(19) United States
(12) Patent Application Publication
(10) Pub. No.: US 2005/0203857 A1
(43) Pub. Date: Sep. 15, 2005

(54) Methods for transaction processing

(76) Inventor: Lawrence J. Friedman, Clifton Park, NY (US)

Correspondence Address: Schmeiser, Olsen & Watts LLP, Suite 201, 3 Lear Jet Lane, Latham, NY, 12110, US

(21) Appl. No.: 11/089,618

(22) Filed: Mar. 25, 2005

Related U.S. Application Data
(63) Continuation-in-part of application No. 10/796,383, filed on Mar. 9, 2004.

(51) Int. Cl. G06F 17/60

(52) U.S. Cl. 705/78

(57) ABSTRACT

A method for transaction processing is presented. In particular, the present invention discloses a method for transaction processing which includes receiving a third party transaction, receiving financial information of the third party transaction where the financial transaction further includes a Magnetic Ink Character Recognition (MICR) data and a representation of the third party transaction; and settling the third party transaction.

### CROSS-REFERENCE TO RELATED APPLICATION

This application is a Continuation-In-Part of copending U.S. patent application Ser. No. 10/796,383, filed on Mar. 9, 2004.

### BACKGROUND OF THE INVENTION

1. Field of Invention

The present invention relates generally to the payment for goods or services using financial transactions, and more particularly, the present invention relates to methods for check and check related processing at a Point of Banking (POB).

2. Related Art

Methods and systems for payment for goods, services, or privileges during financial transactions with debit cards, credit cards, smart cards, very smart cards, money access cards, pre-paid cards, loyalty cards, checks, a Host Based Smart (HBS) card, and the like. have been developed to facilitate the use of the aforementioned at the POB.

Payment via checks account for about 50%-60% of all financial transactions currently conducted at the present. The drawbacks associated with the use of checks include the time needed to fill out the check by the check holder, a substantial decrease in customer processing in a checkout lane, bank fees for tendering check payments, and labor and system expenses.

There is a need for improved methods for processing financial transactions, especially checks, at the POB.

### SUMMARY OF THE INVENTION

The present invention provides a method for financial transactions which overcomes at least one of the aforementioned deficiencies and provides a method for financial transactions, especially check and check related transactions, that can be used at a Point of Banking (POB).

A first general aspect of the present invention provides a method of transaction processing comprising: receiving a third party transaction; receiving financial information of said third party transaction, wherein said financial information comprises at least a Magnetic Ink Character Recognition (MICR) data and a representation of said third party transaction; and settling said third party transaction.

A second general aspect of the present invention provides a method of transaction processing comprising: providing a Magnetic Ink Character Recognition (MICR) reader operably adaptable to a Point of Banking (POB) system; providing a scanner operably adaptable to said POB system; receiving a third party transaction at said POB system; receiving financial information of said third party transaction, wherein said financial information comprises at least said MICR data and a representation of said third party transaction; and settling said third party transaction.

A third general aspect of the present invention provides a method of transaction processing comprising: providing a third party transaction; providing financial information of said third party transaction, wherein said financial information comprises at least a Magnetic Ink Character Recognition (MICR) data and a representation of said third party transaction; and settling said third party transaction.

### BRIEF DESCRIPTION OF THE DRAWINGS

The features of the present invention will best be understood from a detailed description of the invention and an embodiment thereof selected for the purpose of illustration and shown in the accompanying drawing in which:

FIG. 1A depicts a first face of a government issued card, in accordance with the present invention;

FIG. 1B depicts a second face of the government issued card, in accordance with the present invention;

FIG. 2 depicts a method for a Host Based Smart (HBS) card, in accordance with the present invention;

FIG. 3 depicts a flow chart for populating a database with informational elements, in accordance with the present invention;

FIG. 4 depicts a system view of the HBS card, in accordance with the present invention;

FIG. 5 depicts a flow chart of ascribing a unique modifier to the informational elements, in accordance with the present invention;

FIG. 6 depicts a flow chart of ascribing a transactional account to the unique modifier, in accordance with the present invention;

FIG. 7 depicts a method for system maintenance of a HBS card, in accordance with the present invention;

FIG. 8 depicts a flow chart of managing informational elements, in accordance with the present invention;

FIG. 9 depicts a flow chart of managing transactional accounts, in accordance with the present invention;

FIG. 10 depicts a method for maintenance of the HBS card, in accordance with the present invention;

FIG. 11 depicts a flow chart of managing the HBS card, in accordance with the present invention;

FIG. 12 depicts a method for purchasing goods and services using the HBS card, in accordance with the present invention;

FIG. 13 depicts a method for selling goods and services using a HBS card, in accordance with the present invention;

FIG. 14 depicts an embodiment of a flow chart of a method for transaction processing, in accordance with present invention;

FIG. 15 depicts a system view for transaction processing, in accordance with the present invention;

FIG. 16 depicts a second embodiment of a method for transaction processing, in accordance with the present invention; and

FIG. 17 depicts a third embodiment of a method for transaction processing, in accordance with the present invention.

### DETAILED DESCRIPTION OF THE INVENTION

Although certain embodiments of the present invention will be shown and described in detail, it should be understood that various changes and modifications may be made without departing from the scope of the appended claims. The scope of the present invention will in no way be limited to the number of constituting components, the materials thereof, the shapes thereof, the relative arrangement thereof, etc . . . , and are disclosed simply as an example of an embodiment. The features and advantages of the present invention are illustrated in detail in the accompanying drawing, wherein like reference numeral refer to like elements throughout the drawings. Although the drawings are intended to illustrate the present invention, the drawings are not necessarily drawn to scale.

The following are definitions:

Government issued card as used herein is a card issued by a federal, a state, or a municipal government. Examples of the card issued by the federal government may include but are not limited to passports, national identification cards, military cards, social security cards, federal officer identification cards, federal employee cards, federal official cards, and the like.

Examples of the card issued by the state government may include but are not limited to a driver's license, an approved non-driver identification card, a welfare card, a state officer identification card, a state employee card, a state official card, and the like. Examples of the card issued by the municipal government may include but are not limited to a municipal officer identification card, a municipal employee card, a state official card, and the like.

Informational element as used herein is an identifier of an individual that is unique to the individual. The identifier is used to recognize or establish as being a particular individual and to verify the identity of the individual. Examples of informational elements may include but are not limited to a graphic representation of an individual, a graphic representation of a fingerprint, a graphic representation of an individual's iris, a representation of an individual's DNA, an identification number, a retinal scan, and the like.

The graphic representation of an individual as used herein is a portrayal, picturing, or other rendering in a form that accurately depicts the individual being represented. Graphic representations may include but are not limited to digital photographs, laser embossed photographs, film based photographs, sketches, computer generated pictures, and the like.

The residence information as used herein is information relating to a place of domicile, such as a house or an apartment, in which a person lives or dwells. Examples of residence information include but are not limited to a street address, a state of residence, a county of residence, a borough of residence, a village of residence, and the like.

Th graphic representation of a fingerprint as used herein is a portrayal, picturing, or other rendering in a form that accurately depicts the individual's fingerprint. Examples of graphic representations may include but are not limited to digital prints, laser embossed prints, film based prints, sketches of prints, computer generated prints, and the like.

The graphic representation of an individual's iris as used herein is a portrayal, picturing, or other rendering in a form that accurately depicts the individual's iris being represented. Examples of graphic representations may include but are not limited to digital photographs, laser embossed photographs, film based photographs, sketches, computer generated pictures, and the like.

The representation of an individuals's DNA as used herein is a portrayal, picturing, or other rendering in a form that accurately depicts an individuals's DNA/molecular signature that is unique to the individual and can not be mistaken for another individual. Examples include but are not limited to samples of an individual's DNA, recreations of an individual's DNA likeness, and the like.

The identification number as used herein is a number, an alpha-numeric number, and the like that is assigned to the government issued card for means of identifying an individual to which the government card was issued to.

The bar code as used herein is a medium of identifying patterns affixed to the government issued card that is used for storage and retrieval of informational elements. Examples may include but are not limited to bar codes on government issued cards, credit cards, check cards, loyalty cards, and the like.

The magnetic stripe as used herein is a brown or black plastic-like tape that has encased within it magnetic particles of resin. Informational elements may be coded, stored, and retrieved via the arrangement of the magnetic particles. Examples include but are not limited to magnetic stripes on government issued cards, credit cards, check cards, loyalty cards, and the like.

The data chip as used herein is a chip that contains a storage medium; a means to access the storage medium; a means to populate the storage medium with information; and a means to retrieve the information.

The molecular chip as used herein is a chip made of unit molecules and has dimensions on a molecular level. The chip contains a storage medium; a means to access the storage medium; a means to populate the storage medium with information; and a means to retrieve the information.

A unique modifier as used herein is an identifier that is unique and can not be mistaken for another identifier. Examples may include but are not limited to alpha characters, numeric characters, alpha-numeric characters, and the like.

A transactional account as used herein is an accommodation or service extended by an institution to a customer or client permitting the use of the accommodation or service towards goods or services. Examples of transactional accounts may include but are not limited to a credit card, a checking account, a debit card, a loyalty card, a membership card, and the like.

An Internal Host as used herein is a computer system containing data, programs, databases, data transmission networks, and combinations thereof that can communicate with and access other computer systems with permission of the computer system to be accessed and can be accessed by other computer systems with permission of the Internal Host.

An External Authorizing host as used herein is a computer system containing data, programs, databases, data transmission networks, and combinations thereof that can access other computer systems with the permission of the computer system to be accessed and can be accessed by other computer systems with the permission of the External Authorizing Host. Examples may include but are not limited to U.S. banks or international banks, the U.S. Treasury Department's Office of Foreign Asset Control, the Internal Revenue Service, the Department of Homeland Security, credit unions, consumer credit monitoring agencies, and the like.

An electronic peripheral as used herein is a device that can read a card having informational elements stored on the card and obtain the informational elements encoded. Examples may included but are not limited to a scanner, a radio frequency (RF) reader, wireless devices, voice recognition devices, point of sales (POS) systems, and the like.

The POS system is a sales, marketing, and inventory management system where financial transactions take place. A POS system includes devices selected from a group comprising of a computer, software, electronically controlled cash drawer, a receipt printer, a bar code scanning device, a magnetic card reading device, a check reading device, hardware and software for Internet access and communication, hardware and software for communication with wireless devices, docking bays and ports for communication with flash/temporary memory devices, a display, and combinations thereof.

Typically, POS systems are located at areas where sales of goods and services take place. Examples of where POS systems may be used include but are not limited to retail stores, hospitals, restaurants, drinking establishments, gas stations, e-commerce business, wholesale distribution outlets, and the like.

A data transmission network as used herein is a system containing computers, computer terminals, printers, audio or visual display devices, servers or telephones and wireless devices interconnected by telecommunication equipment or cables used to transmit or receive information and combinations thereof.

A server as used herein is a computer system that makes services, as access to data files, programs, and peripheral devices, available to workstations or other computer systems on a network.

Goods and services as used herein are products, merchandise, benefits, features, advantages, assistance, and rights granted by a provider of the goods and services. Examples of goods may include but are not limited to food, clothing, shelter, automobiles, toys, and the like. Examples of services may include but are limited to electronic fund transactions, credit card transactions, debit card transactions, money access card transactions, loyalty card transactions, AAA membership, repair services, insurance, and the like.

Customer Segmentation as used herein is the practice of dividing a customer base into groups of individuals that are similar in specific ways relevant to marketing, such as age, gender, interests, spending habits, and the like. Spending habits of customers are often rated based upon the frequency of usage and the average dollars transacted per usage. Value-based segmentation looks at groups of customers in terms of the revenue they generate and the costs of establishing and maintaining relationships with them. Examples of value-based segmentation categories include but are not limited to a platinum status, a gold status, a silver status, a blue status, and the like.

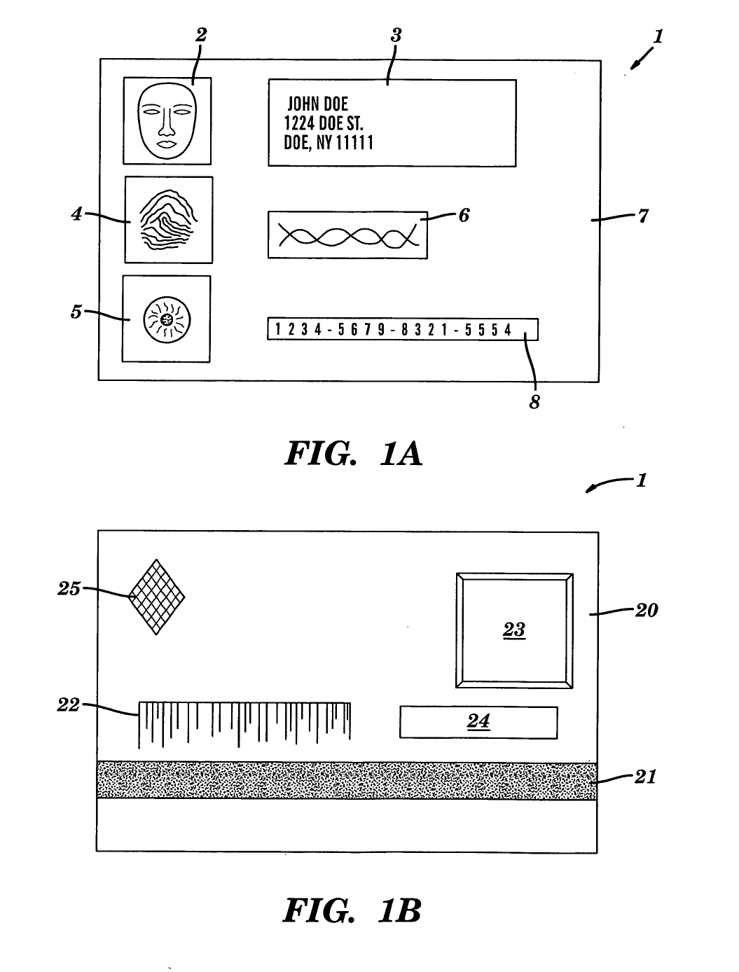

FIG. 1A depicts a first face 7 of a government issued card 1 comprising informational elements: a graphic representation of an individual 2; a residence information 3; a graphic representation of a fingerprint 4; a graphic representation of an individual's iris 5; a representation of an individual's DNA 6, and an identification number 8.

FIG. 1B depicts a second face 20 of the government issued card 1 comprising: a magnetic stripe 21, a bar code 22, a data chip 23, a molecular chip 24, and a retinal scan 25.

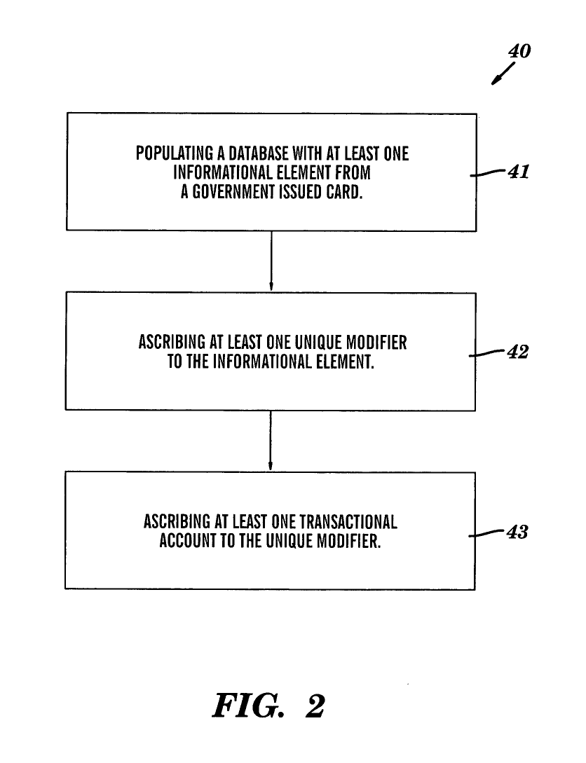

FIG. 2 depicts an embodiment of the present invention, a method 40 for a Host Based Smart (HBS) card comprising: a step 41, populating a database with at least one informational element from the government issued card; a step 42, ascribing at least one unique modifier to the informational element; and a step 43, ascribing at least one transactional account to the unique modifier.

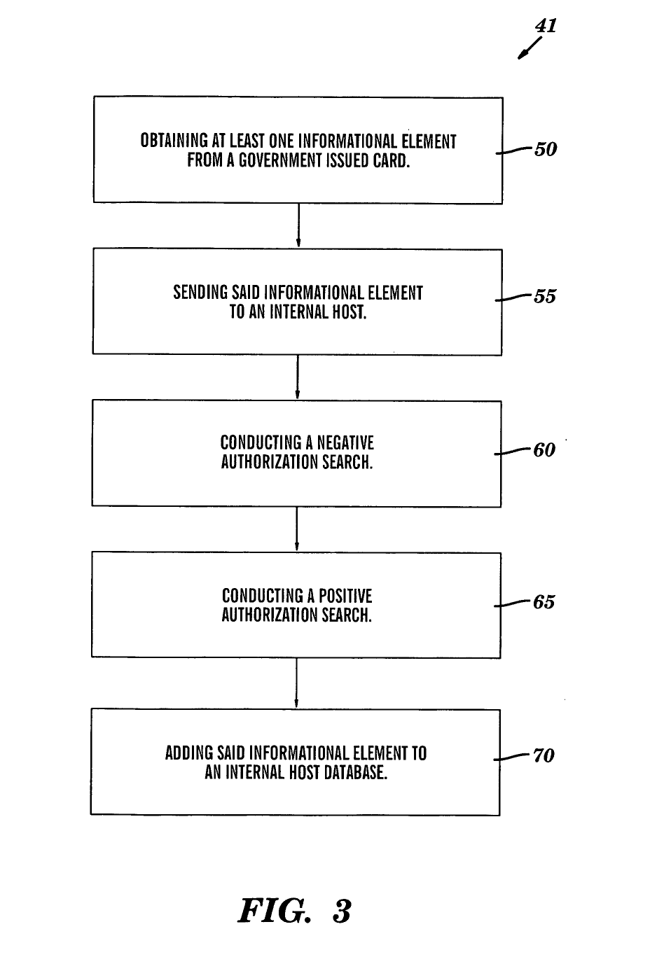

FIG. 3 depicts a flow chart of the step 41, populating a database with informational elements from the government issued card 1, of the method 40 of FIG. 2. Step 41 further comprises: a step 50, obtaining at least one informational element from the government issued card 1; a step 55, sending the informational element to an Internal Host; a step 60, conducting a negative authorization search; a step 65, conducting a positive authorization search; and a step 70, adding at least one informational element to an Internal Host Database.

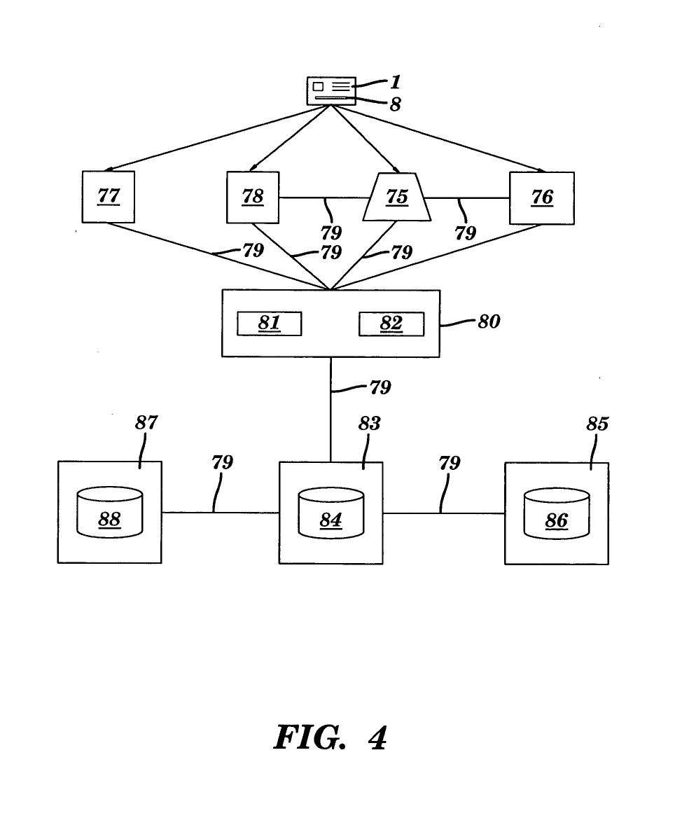

FIG. 4 depicts a system view of an embodiment of the present invention. As shown in FIG. 3 and FIG. 4, a step 41 of the method 40, one embodiment of the present invention focuses on populating a database with informational elements from the government issued card 1, wherein the card 1 is a state issued driver's license or approved-non driver identification and the informational element is an identification number 8.

As shown in FIG. 3 and FIG. 4, the step 50, obtaining the informational element from the government issued card 1, of the step 41, the government issued card 1 may be inserted into an electronic peripheral 75. The electronic peripheral 75 reads the magnetic stripe 21 or the bar code 22 on the government issued card 1 to obtain the informational element, i.e. the number 8. The electronic peripheral 75 may also scan and capture the graphical representation of the individual 2 of the government issued card 1 as well as capture a graphical representation of the entire card 1.

Alternatively, it can be envisioned where the government issued card 1 may have a data chip 23 imbedded within the body of the card 1. It is envisioned where the data chip 23 may contain informational elements such as the graphic representation of an individual 2, the residence information 3, the graphic representation of a fingerprint 4; the graphic representation of an individual's iris 5, the representation of an individual's DNA 6, the identification number 8, and the like. The data chip 23 may be read by an electronic peripheral 75 and similar devices.

Alternatively, obtaining informational elements from the government issued card 1 may be accomplished via a radio frequency (RF) reader 76. An individual may pass their government issued card 1 over the RF reader 76 which uses a RF transponder to activate the data chip 23 within the card 1. Informational elements such as the graphic representation of an individual 2; the residence information 3; the graphic representation of a fingerprint 4; the graphic representation of an individual's iris 5; the representation of an individual's DNA 6, the identification number 8, and the like would be wirelessly transmitted via RF to the RF reader 76. The RF reader 76 may be a stand alone unit that is connected to the electronic peripheral 75 via standard data transmission lines 79 or the RF reader 76 may be part of the electronic peripheral 75.

Alternatively, it can be envisioned that wireless devices 77 such as cell phones, PDAs such as Palm Pilots™, Handspring Visor™, Handspring Treo™, and the like can be used to obtain the informational elements. Such devices could obtain the informational elements via scanning technology used to read the magnetic strip 21 or the bar code 23, or have said informational elements manually inputted into said devices via physical or virtual keyboards.

Alternatively, one can obtain informational elements like the identification number 8, the address information 3, and the like via speech technology. Voice recognition software and voice recognition devices 78 are able to transcribe speech into text for use by an electronic peripheral 75. The voice recognition devices 78 may be a stand alone units that are connected to the electronic peripheral 75 via data transmission networks 79 or may be physically part of the electronic peripheral 75.

The informational elements obtained by the electronic peripheral 75, the RF reader 76, wireless devices 77, and the voice recognition devices 78 may be temporarily stored in a server 80 connected to the aforementioned devices via data transmission networks 79. The server 80 may be a local server 81, such as a POS server or an in-store server, or an off-site server 82, such as a retail headquarter server or a chain headquarter server that is off-site but connected to the electronic peripheral 75 or any combination thereof, voice recognition devices 78, wireless devices 77, and RF readers 76 via typical data transmission networks 79. Alternatively, for smaller companies and businesses, the Internal Host 83 may also function as the off-site server 82 as well as function as the Internal Host simultaneously.

As shown in FIG. 3 and FIG. 4 for points of illustration; the step 55, sending the informational element to an Internal Host 83, of the step 41, the informational element obtained via step 50 is temporarily stored in the server 80, local 81 or off-site 82, may be sent to the Internal Host 83 from the server 80. The server 80 then sends the informational element, the identification number 8, to the Internal Host 83 via data transmission networks 79 wherein the informational element is stored in an Internal Host database 84.

As shown in FIG. 3 and FIG. 4 for points of illustration; the step 60, conducting a negative authorization search, of the step 41, the Internal Host 83 may conduct a negative authorization search of the Internal Host database 84 by searching for a duplicate match of the identification number 8 or a match of the identification number 8 in a negative file. The negative file is a file that contains a transaction history of the individual that indicates whether the individual has unresolved financial issues that would not make them preferable for use of or membership to a HBS card.

The Internal Host 83 also has the ability to conduct a negative authorization search with an External Authorizing Host 85 looking for a match in a negative file that may not be in the Internal Host database 84. The External Authorizing Host 85 that is used for a negative authorization search may be an institution that offers credit cards, debt cards, checking privileges, or any services related to financial transactional accounts; and that keeps records of the financial transactional accounts.

Examples of such institutions include but are not limited to U.S. banks or international banks, the U.S. Treasury Department's Office of Foreign Asset Control, the Internal Revenue Service, the Department of Homeland Security, credit unions, and consumer credit monitoring agencies. The External Authorizing Host 85 searches an External Authorizing Host database 86 for a match, in a negative file, to the identification number 8 submitted. If a match is found, the step method 40 is terminated and the identification number 8 is placed in a negative file located in the Internal Host database 84. If a negative authorization search does not find a duplicate match or a match in a negative file, the method 40 is allowed to continue.

As shown in FIG. 3 and FIG. 4 for points of illustration; the step 65, conducting a positive authorization search, of the step 41, the Internal Host 83 sends the identification number 8 of the government issued card 1 to another External Authorizing Host 87 for a positive authorization search. The External Authorizing Host 87 used for a positive authorization search is one that maintains secure information relating to informational elements and personal information of a government issued card 1. Examples of such External Authorizing agents may include but are not limited to a state's Department of Motor Vehicles, the Immigration and Naturalization Service, the Federal Bureau of Investigation, the Internal Revenue Service, the Department of Homeland Security, the Central Intelligence Agency, the International Criminal Police Organization, the National Security Agency, and the like.

The External Authorizing Host 87 searches an External Authorizing Host database 88 for a positive match to the identification number 8 submitted. If the External Authorizing Host 87 finds a match, the host then will send back to the Internal Host 83 informational elements on file in the External Authorizing Host database 88 that correspond to the identification number 8 as well as any personal information that would potentially place the person submitted in a negative file on the Internal Host database 83. This information may include but is not limited to red flag information such as a stolen driver's license, an illegal alien, a terrorist suspect, an international fugitive, a domestic fugitive, a member of the F.B.I. top ten wanted list, and the like.

Red flag information associated with the identification number 8 will cause the Internal Host 83 to then terminate the method 40 and place the identification number 8 in a negative file. All red flag information related to national security will automatically create an exception file in the Internal Host database 84. The exception file then would be sent to the appropriate national security organization for reconciliation. Examples of national security organizations include but are not limited to the Immigration and Naturalization Service, the Federal Bureau of Investigation, the Internal Revenue Service, the Department of Homeland Security, the Central Intelligence Agency, the International Criminal Police Organization, the National Security Agency, and the like.

If the External Authorizing Host 87 does not find a match to the identification number 8 submitted, the External Authorizing Host 88 will send a file not found notification to the Internal Host 83. The Internal Host 83 will then terminate the method 1 and place identification number 8 in a negative file.

As shown in FIG. 3 and FIG. 4 for points of illustration; the step 70, adding said informational elements to the Internal Host database 84, of the step 41, if a negative authorization search, of the step 60, yields no matches and a positive authorization search, of the step 65, yields a match with no red flag information, the Internal Host 83 then adds the informational elements to the Internal Host database 84. The informational element is stored as the identification number 8 of the government card 1, specifically the state issued driver's license number or an approved non-driver identification number.

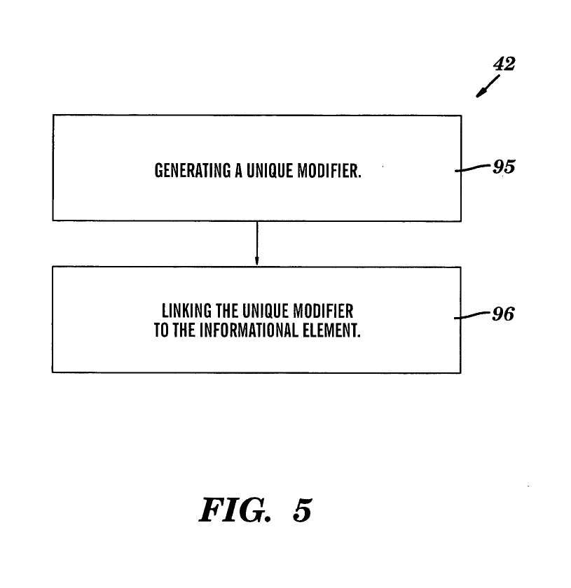

FIG. 5 depicts the step 42, ascribing at least one unique modifier to the informational element, of the method 40 of FIG. 1. Step 42 further comprises: a step 95, generating a unique modifier; and a step 96, linking the unique modifier to the informational element. In an embodiment of the present, the informational element is the government issued card 1 identification number 8; specifically the state issued driver's license number or approved non-driver identification number. As shown in FIG. 4 and FIG. 5, the step 95, generating a unique modifier, the Internal Host 83 generates a unique modifier via computer science methodology. Examples of the methodologies may include but are not limited to off-the-shelf retail software, in-house proprietary software, and the like. The unique modifiers generated may be numerical, alphabetic, symbolic, alpha-numeric, and the like as well as combinations thereof.

As shown in FIG. 4 and FIG. 5, the step 96, linking the unique modifier to the informational element, the Internal Host 83 links the unique modifier generated in the step 95 to the informational element via computer science methodology. Examples of the methodologies may include but are not limited to off-the-shelf retail software, in-house proprietary software, and the like as well as combinations thereof. The informational elements used are the elements that have been previously populated in the Internal Host database 84 by the step 41 of the method 40. The result of the steps 95 and 96 is an informational element having a unique modifier ascribed to the informational element.

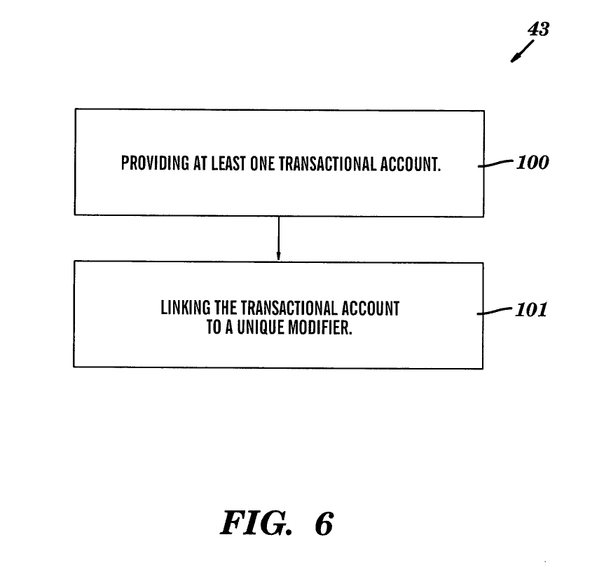

FIG. 6 depicts the step 43, ascribing at least one transactional account to the unique modifier, of the method 40 of FIG. 2. Step 43 further comprises: a step 100, providing the transactional account; and a step 101, linking the transactional account to the unique modifier of step 42 of the method 40.

As shown in FIG. 4 and FIG. 6, the step 100, one embodiment of the present invention focuses on providing the transactional account wherein the transactional account is a checking account. A check may be inserted into an electronic peripheral 75. The electronic peripheral 75 reads a Magnetic Ink Character Recognition (MICR) of the check to obtain the account information, such as a routing number, the checking account number, and the check number. The electronic peripheral 75 may also scan and capture a graphical representation of the check.

Alternatively, it can be envisioned where the check may have a data chip 23 imbedded within the body of the check. It is envisioned where the data chip 23 may contain account information such as the graphic representation of the check, the routing number, the checking account number, the check number, and the like. The data chip 23 may be read by an electronic peripheral 75 or similar devices.

Alternatively, obtaining checking information from a check may be accomplished via a radio frequency (RF) reader 76. An individual may pass their check over a RF reader 76 which uses a RF transponder to activate the data chip 23 within the card 1. Checking account information such as the graphic representation of the check; the routing number; the checking account number, the check number, and the like would be wirelessly transmitted via RF to the RF reader 76. The RF reader 76 may be a stand alone unit that is connected to the electronic peripheral 75 via standard data transmission lines 79 or the RF reader 76 may be part of the electronic peripheral 75.

Alternatively, it can be envisioned that wireless devices 77 such as cell phones; PDAs such as Palm Pilots™, Handspring Visor™, Handspring Treo®, and the like can be used to provide checking account information. Such devices could provide the account information via scanning technology used to read the MICR, or have the MICR manually inputted into said devices via physical or virtual keyboards.

Alternatively, one can provide the checking account information such as the routing number, the checking account number, the check number, and the like via speech technology. Voice recognition software and voice recognition devices 78 are able to transcribe speech into text for use by an electronic peripheral 75. The voice recognition devices 78 may be a stand alone units that are connected to the electronic peripheral 75 via data transmission networks 79 or may be physically part of the electronic peripheral 75.

The checking account information obtained by the electronic peripheral 75, the RF reader 76, wireless devices 77, and the voice recognition devices 78 may be temporarily stored in a server 80 connected to the aforementioned devices via data transmission networks 79. The server 80 may be a local server 81, such as a POS server or an in-store server, or an off-site server 82, such as a retail headquarter server or a chain headquarter server that is off-site but connected to the electronic peripheral 75 or any combination thereof, voice recognition devices 78, wireless devices 77, and RF readers 76 via typical data transmission networks 79.

The checking account information provided is temporarily stored in the server 80, local 81 or off-site 82, may be sent to the Internal Host 83 from the server 80. The server 80 then sends the account information to the Internal Host 83 via data transmission networks 79 wherein the account information is stored in an Internal Host database 84.

The Internal Host 83 may conduct a negative authorization search of the Internal Host database 84 by searching for a duplicate match of the checking account information or a match in a negative file. The negative file is a file that contains a transaction history of the individual that indicates whether the individual has unresolved financial issues that would not make them preferable for use of or membership to the HBS card.

The Internal Host 83 also has the ability to conduct a negative authorization search with an External Authorizing Host 85 looking for a match in a negative file that may not be in the Internal Host database 84. The External Authorizing Host 85 that is used for a negative authorization search may be an institution that offers credit cards, debt cards, checking privileges, or any services related to financial transactional accounts, and that keeps records of the financial transactional accounts.

Examples of such institutions may include but are not limited to U.S. banks or international banks, the U.S. Treasury Department's Office of Foreign Asset Control, the Internal Revenue Service, the Department of Homeland Security, credit unions, and consumer credit monitoring agencies. The External Authorizing Host 85 searches an External Authorizing Host database 86 for a match, in a negative file, to the checking account number submitted. If a match is found, the step 43 is terminated and the account number is placed in a negative file located in the Internal Host database 84. If a negative authorization search does not find a duplicate match or a match in a negative file, the step 43 is allowed to continue.

The Internal Host 83 sends the account information to another External Authorizing Host 87 for a positive authorization search. The External Authorizing Host 87 used for a positive authorization search is one that maintains secure information relating to transactional accounts and personal information related to the account. Examples of such External Authorizing agents may include but are not limited to a state's Department of Motor Vehicles, the Immigration and Naturalization Service, the Federal Bureau of Investigation, the Internal Revenue Service, the Department of Homeland Security, the Central Intelligence Agency, the International Criminal Police Organization, the National Security Agency, and the like.

The External Authorizing Host 87 searches an External Authorizing Host database 88 for a positive match to the account number submitted. If the External Authorizing Host 87 finds a match, the host then will send back to the Internal Host 83 account information on file in the External Authorizing Host database 88 that corresponds to the account number as well as any personal information that would place the person submitted in a negative file on the Internal Host database 83. Examples of information may include but are not limited to red flag information such as a stolen driver's license, an illegal alien, a terrorist suspect, an international fugitive, a domestic fugitive, a member of the F.B.I. top ten wanted list, and the like.

Red flag information associated with the identification number 8 will cause the Internal Host 83 to then terminate the step 43 and place the checking account number in a negative file. All red flag information related to national security will automatically create an exception file in the Internal Host database 84. The exception file then would be sent to the appropriate national security organization for reconciliation. Examples of national security organizations may include but are not limited to the Immigration and Naturalization Service, the Federal Bureau of Investigation, the Internal Revenue Service, the Department of Homeland Security, the Central Intelligence Agency, the International Criminal Police Organization, the National Security Agency, and the like.

If the External Authorizing Host 87 does not find a match to checking account number submitted, the External Authorizing Host 88 will send a file not found notification to the Internal Host 83. The Internal Host 83 will then terminate the step 43 and place the account number in a negative file. If a negative authorization search yields no matches and a positive authorization search yields a match with no red flag information, the Internal Host 83 then provides the checking account information to the Internal Host database 84.

As shown in FIG. 4 and FIG. 6, the step 101, one embodiment of the present invention focuses on linking the transactional account to a unique modifier wherein the transactional account is a checking account. The Internal Host 83 links the checking account number to the unique modifier previously ascribed to an informational element that was used to populate the Internal Host Database 84 of the step 41 of the method 40.

The linking is accomplished via computer science methodology. Examples of methodologies may include but art not limited to off-the-shelf retail software, in-house proprietary software, and the like. The transactional account will be now ascribed to the informational element via the unique modifier and stored in the Internal Host database 84.

The results of the step 41, the step 42, and the step 43 of the method 40 is a government issued card 1, specifically the state issued driver's license or the approved non-driver identification card that is now effectively equivalent to a checking account and is afforded any associated checking privileges, i.e. a HBS card, through the method of having the checking account ascribed to the state issued driver's license or the approved non-driver identification number via the unique modifier. The state issued driver's license or the approved non-driver identification card can be used for limited check cashing privileges until a positive check cashing history has been achieved. Once the checking account has been ascribed to the state issued driver's license or the approved non-driver identification via the modifier, an individual no longer is required to present a check for checking privileges.

Limited check cashing privileges entail check velocity and check amount limits per week. For example, 2-3 checks may be written for the first three weeks without the aggregate sum not exceeding $300 per week. The second three weeks may include 3-5 checks without the aggregate sum not exceeding $600. Any number of variations of check velocity and check amount limits can be envisioned for developing a positive check cashing history. The more positive a customer's check cashing history is, the greater the check velocity and check amount limits can be.

Alternatively, a transactional account such as a credit card may also be linked to the unique modifier as well as debit cards, loyalty cards, retail cards, membership cards, and the like. Once the transactional accounts of the aforementioned cards have been linked to the government issued card 1, the cards are no longer required to be presented for the use of services and privileges associated.

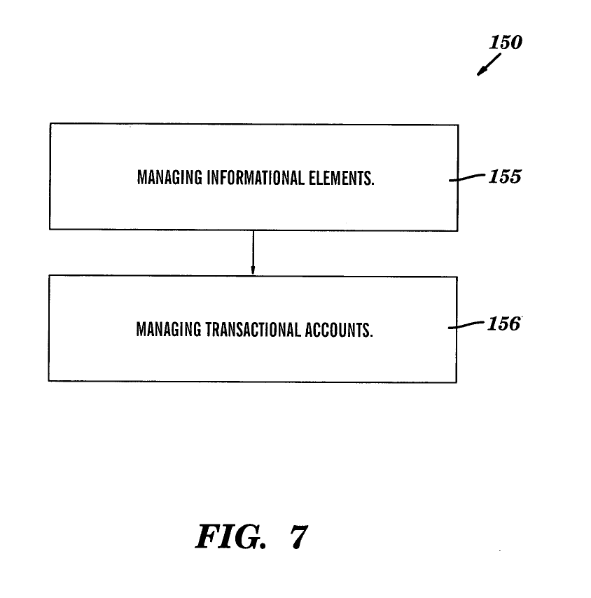

FIG. 7 depicts an embodiment of the present invention, a method 150 for system maintenance of a Host Based Smart (HBS) card comprising: a step 155, managing informational elements; and a step 156 managing transactional accounts.

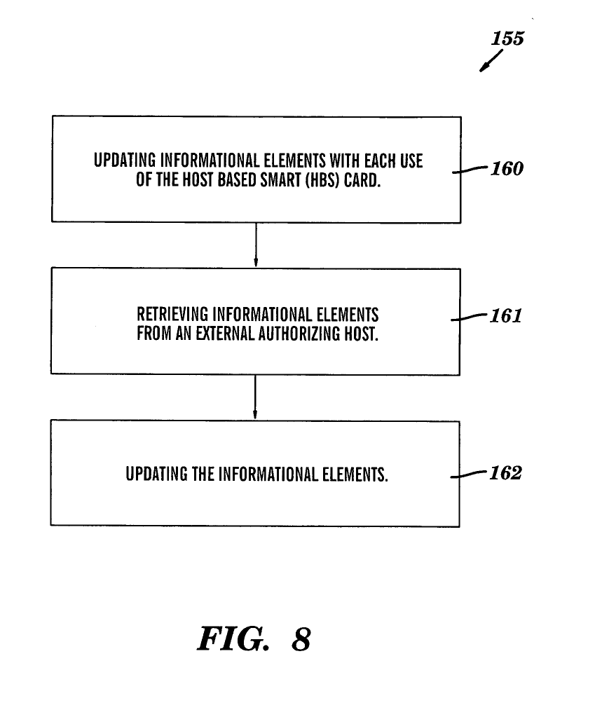

FIG. 8 depicts a flow chart of the step 155, managing informational elements, of the method 150. The step 155 further comprises: a step 160, updating informational elements with each use of the HBS card; a step 161, retrieving informational elements from an external authorizing host; and a step 162, updating the informational elements.

As shown in FIG. 4 and FIG. 8, the step 160, one embodiment of the present invention focuses on updating informational elements with each use of the HBS card, wherein the card is a state issued driver's license or approved non-driver identification card. Each time the HBS card is inserted into an electronic peripheral 75. The electronic peripheral 75 reads the magnetic stripe 21 or bar code 22 on the HBS card to obtain the informational elements encoded in the magnetic. The electronic peripheral 75 also scans and captures the informational elements on the HBS card.

In an alternative embodiment, it can be envisioned where the HBS card may have a data chip 23 imbedded within the body of the HBS card. The data chip 23 would contain informational elements such as the graphic representation of an individual 2, the residence information 3, the graphic representation of a fingerprint 4, the graphic representation of an individual's iris 5, the representation of an individual's DNA 6, the identification number 8, and the like. The chips may be read by an electronic peripheral 75 and similar devices.

In an alternative embodiment, obtaining informational elements from a HBS card may be accomplished via a radio frequency (RF) reader 76. An individual may pass their HBS card over a RF reader 76 which uses a RF transponder to activate the data chip within said HBS card. The informational elements of the HBS card would be wirelessly transmitted via radio frequency to the RF reader 76. The RF reader 76 may be a stand alone unit that is connected to the electronic peripheral 75 via standard data transmission lines 79 or the RF reader 76 may be part of the electronic peripheral 76.

In an alternative embodiment, it can be envisioned that obtaining informational elements from a HBS card may be accomplished via wireless devices 77 such as cell phones; PDAs such as Palm Pilots™, Handspring Visor™, Handspring Treo™, and the like. Such devices would obtain the informational elements via scanning technology or have the informational elements obtained via manually inputting the informational elements into the devices via physical or virtual keyboards.

In an alternative embodiment, informational elements may be obtained via voice recognition technology. Current voice recognition software and voice recognition devices 78 are able to transcribe voice into text for use by an electronic peripheral 75. The voice recognition devices 78 may be a stand alone unit that is connected to the electronic peripheral 75 via data transmission networks 79 or may be part of the electronic peripheral 75.

The informational elements obtained by the electronic peripheral 75, the RF reader 76, wireless devices 77, and the voice recognition devices 78 may be temporarily stored in a server 80 connected to the aforementioned devices via data transmission networks 79. The server 80 may be a local server 81, such as a POS server or an in-store server, or an off-site server 82, such as a retail headquarter server or a chain headquarter server that is off-site but connected to the electronic peripheral 75 or any combination thereof, via voice recognition devices 78, wireless devices 77, and RF readers 76 using typical data transmission networks 79 that may be temporarily stored in servers 17 connected to the aforementioned devices. The servers may be a local server 81, such as a POS or in-store server, or an off-site server 82, such as a retail headquarter or chain headquarter server that is off-site but connected to the electronic peripheral 75, voice recognition devices 78, wireless devices 77, and RF readers 76 via data transmission networks 79.

The informational elements provided are temporarily stored in the server 80, local 81 or off-site 82, may be sent to the Internal Host 83 from the server 80. The server 80 then sends the account information to the Internal Host 83 via data transmission networks 79 wherein the account information is stored in an Internal Host database 84.

The Internal Host 83 may conduct a negative authorization search of the Internal Host database 84 by searching for a duplicate match of the checking account information or a match in a negative file. The negative file is a file that contains a transaction history of the individual that indicates whether the individual has unresolved financial issues that would not make them preferable for use of or membership to a HBS card. The informational elements just obtained are compared to informational elements previously used to populate the Internal Host database 84, of the step 41 of the method 40 of FIG. 2.

If the Internal Host 83 identifies any differences between the two sets of informational elements or discovers a new informational element that was not previously used to populate the Internal Host database 84, the Internal Host 83 will replace any old informational elements on the Internal Host database 84 with the new informational elements or add new informational elements to the Internal Host database 84 that were not previously used to populate the Internal Host database 84.

As shown in FIG. 4 and FIG. 8, a step 161, retrieving informational elements from an External Authorizing Host 22, of the step 155 of the method 150, an embodiment of the present invention focuses on retrieving informational elements from an External Authorizing Host 84 wherein the informational element is a state issued driver's license or approved-non driver identification number of the HBS card.

The Internal Host 84 may randomly, on a predetermine schedule, by command of an Internal Host administrator, or with each use of the HBS card retrieve informational elements from an External Authorizing Host 87. The Internal Host 83 contacts the External Authorizing Host 87 via the data transmission network 79. The Internal Host 83 then sends the HBS card number to the External Authorizing Host 88 for a positive authorization search. The External Authorizing Host 88 used is one that maintains secure information relating to the informational elements and the personal information of an individual.

Examples of such External Authorizing agents may include but are not limited to a state's Department of Motor Vehicles, the Immigration and Naturalization Service, the Federal Bureau of Investigation, the Internal Revenue Service, the Department of Homeland Security, the Central Intelligence Agency, the International Criminal Police Organization, the National Security Agency, and the like.

The External Authorizing Host 87 searches within the External Host database 88 for a positive match to the HBS card number submitted. If the External Authorizing Host 88 finds a match, the host 88 then sends back to the Internal Host 84 informational elements that correspond to the HBS card number.

As shown in FIG. 4 and FIG. 8, a step 162, updating informational elements from an External Authorizing Host 88, of the step 155 of the method 150. The informational elements retrieved, of the step 161, are compared to informational elements previously used to populate the Internal Host database 84, of the step 41 of the method 40 of FIG. 2.

If the Internal Host 83 identifies any differences between the two sets of informational elements or identifies a new informational element that was not previously used to populate the Internal Host database 84, the Internal Host 83 will replace any old informational elements on the Internal Host database 84 with the new informational elements or add new informational elements, submitted by the External Authorizing Host 87, in the Internal Host database 84 that were not previously used to populate the Internal Host database 84.

Updated informational elements of the HBS card pertaining to red flag information in nature may place the HBS card in a negative file on the Internal Host's database 84. Examples of this information may include but are not limited to red flag information such as a stolen driver's license, an illegal alien, a terrorist suspect, an international fugitive, a domestic fugitive, a member of the F.B.I. top ten wanted list and the like.

All red flag information associated with the HBS card and related to national security will automatically create an exception file in the Internal Host database. The exception file then would be sent to the appropriate national security organization for reconciliation. Examples of national security organizations may include but are not limited to the Immigration and Naturalization Service, the Federal Bureau of Investigation, the Internal Revenue Service, the Department of Homeland Security, the Central Intelligence Agency, the International Criminal Police Organization, the National Security Agency, and the like.

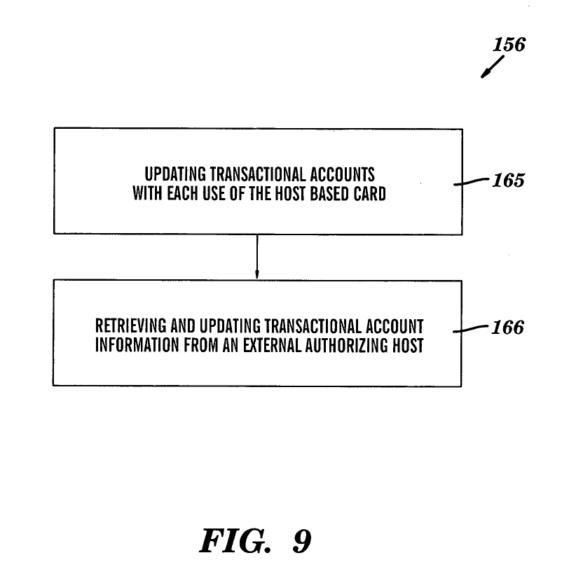

FIG. 9 depicts a flow chart of the step 156, managing transactional accounts, of the method 150. The step 156 further comprises: a step 165, updating transactional account information with each use of the HBS card; and a step 166, retrieving and updating transactional account information from the External Authorizing Host.

As shown in FIG. 4 and FIG. 9; a step 165, updating updating transactional account information with each use of the HBS card, one embodiment of the present invention focuses on updating transactional account information wherein the transactional account is a checking account.

Each time the HBS card is inserted into an electronic peripheral 75. The electronic peripheral 75 reads the magnetic stripe 21 or bar code 22 on the HBS card to obtain the informational elements encoded in the magnetic stripe 21. The electronic peripheral 75 also scans and captures the informational elements on the HBS card.

The informational elements obtained are temporarily stored in a server 80 connected to the aforementioned devices via data transmission networks 79. The server 80 may be a local server 81, such as a POS server or an in-store server, or an off-site server 82, such as a retail headquarter server or a chain headquarter server that is off-site but connected to the electronic peripheral 75 or any combination thereof, voice recognition devices 78, wireless devices 77, and RF readers 76 via typical data transmission networks 79 that may be temporarily stored in a server 80 connected to the aforementioned devices. The server 80 may be a local server 81, such as a POS or in-store server, or an off-site server 82, such as a retail headquarter or chain headquarter server, that are off-site but connected to the electronic peripheral 75, voice recognition devices 78, wireless devices 77, and RF readers 76 via data transmission networks 79.

The informational elements provided are temporarily stored in the server 80, local 81 or off-site 82, may be sent to the Internal Host 83 from the server 80. The server 80 then sends the account information to the Internal Host 83 via data transmission networks 79 wherein the account information is stored in an Internal Host database 84. The Internal Host 20 examines the aforementioned information element and identifies the unique modifier that has been ascribed to it. Subsequently, all transactional accounts linked to the unique modifier are able to be identified. In this example, the checking account to be updated is identified.

The Internal Host 83 then conducts a negative search of the Internal Host database 84 by searching for a duplicate match of the checking account or a match of the checking account in a negative file. The negative file is a file that contains a transaction history of the consumer that indicates whether the consumer has unresolved financial issues that would not make them preferable for use of or membership to a HBS card. If a match is found, the use of the HBS card as a checking transaction is terminated and the checking account linked to the HBS card is placed in a negative file located in the Internal Host database 84. If a negative search does not find a duplicate match or a match in a negative file, the use of the HBS card for checking services and privileges remain.

As shown in FIG. 4 and FIG. 9; the step 166, retrieving and updating transactional accounts from an External Host, of the step 156 of the method 150, one embodiment of the present invention focuses on updating transactional accounts wherein the transactional account is a checking account.

The Internal Host 83 may randomly, on a predetermine schedule, by command of an Internal Host administrator, or automatically with each use of the HBS card update transactional account information from the External Authorizing Host 85. The Internal Host 83 contacts the External Authorizing Host 85 via the data transmission network. The Internal Host 83 then sends the account number of the checking account to the External Authorizing Host 85 for a negative search. The External Authorizing Host 85 then looks within the External Host database 86 for a match in a negative file that may not be in the Internal Host database 84.

The External Authorizing Host 85 that is used for a negative search may be an institution that offers credit cards, debt cards, checking privileges, or any services related to financial transactions and that keeps records of said financial transactions. Examples of such institutions may include but are not limited to U.S. banks or international banks, the U.S. Treasury Department's Office of Foreign Asset Control, the Internal Revenue Service, the Department of Homeland Security, credit unions, consumer credit monitoring agencies, and the like.

The External Authorizing Host 85 searches within the External Host database 86 for a match, in a negative file, to the account number of the checking account submitted. If a match is found, the checking account that is linked to the HBS card is placed in a negative file located in the Internal Host database 84, and the negative file is sent to the requesting server. If a negative search does not find a duplicate match or a match in a negative file, no updates are made to the transactional account.

The above example of the transactional account that was updated from an External Authorizing Host 86 was a a checking account. Alternative transaction accounts that may be updated from an External Authorizing Host 86 may include but are not limited to credit cards, debit cards, money management cards, and the like.

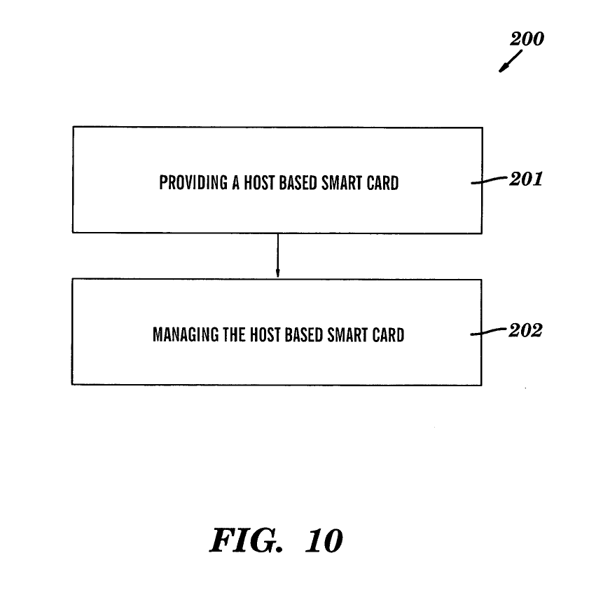

FIG. 10 depicts an embodiment of the present invention, a method 200, for maintenance of a Host Based Smart (HBS) card comprising: a step 201, providing the HBS card; and a step 202, managing the HBS card.

As shown in FIG. 2 and FIG. 10, the step 201 of the method 200, one embodiment of the present invention focuses on providing a HBS card wherein the HBS card was arrived at from the method 40: the step 41, populating a database with at least one informational element from the government issued card; the step 42, ascribing at least one unique modifier to the informational element; and the step 43, ascribing at least one transactional account to the unique modifier.

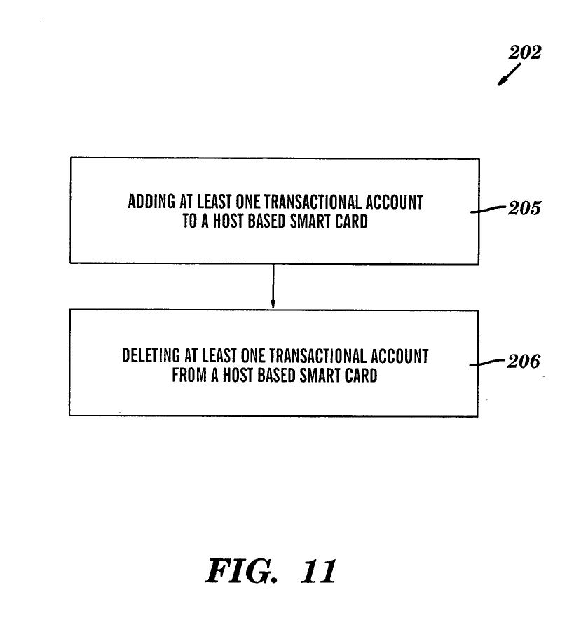

FIG. 11 depicts a flow chart of the step 202, managing the Host Based Smart (HBS) card, of the step 200 of the method 200 of FIG. 10. The step 202, further comprises: a step 205, adding transactional accounts, and a step 206, deleting transactional accounts. As shown in FIG. 4 and FIG. 11, the step 205, an embodiment of the present invention focuses on adding transactional accounts to the HBS card.

A HBS cardholder approaches the electronic peripheral 75 to add a transactional account. In this example, the transactional account to be added is a checking account. The cardholder inserts their HBS card into an electronic peripheral 75. The electronic peripheral 75 reads the HBS card and obtains the informational elements from the card. The cardholder then inputs their PIN and then receives a prompt asking what they would like to do: add a new transactional account, delete a transactional account, or access current HBS account information.

Alternatively, the HBS card may be read via a radio frequency (RF) reader 76. The cardholder may pass their HBS card over a RF reader 76 which uses a RF transponder to activate the data chip 23 within the card. Informational elements such as the graphic representation of an individual 2, the residence information 3, the graphic representation of a fingerprint 4, the graphic representation of an individual's iris 5, the representation of an individual's DNA 6, the identification number 8, and the like would be wirelessly transmitted via radio frequency to the RF reader 76. The RF reader 76 may be a stand alone unit that is connected to the electronic peripheral 75 via standard data transmission lines 79 or the RF reader 76 may be part of the electronic peripheral 75.

Alternatively, it can be envisioned that wireless devices 77 such as cell phones; PDAs such as Palm Pilots®, Handspring Visor®, Handspring Treo®, and the like can be used to read the HBS card. Such devices could obtain the informational elements via scanning technology used to read the magnetic strip 21 or bar code 23, or have the informational elements manually inputted into said devices via physical or virtual keyboards.

Alternatively, one can obtain informational elements like the identification number 8, the address information 3, and the like via speech technology. Voice recognition software and voice recognition devices 78 are able to transcribe speech into text for use by an electronic peripheral 75. The voice recognition devices 78 may be a stand alone unit that is connected to the electronic peripheral 75 via data transmission networks 79 or may be physically part of the electronic peripheral 75.

The informational elements obtained by the electronic peripheral 75, the RF reader 76, wireless devices 77, and the voice recognition devices 78 may be temporarily stored in a server 80 connected to the aforementioned devices via data transmission networks 79. The server 80 may be a local server 81, such as a POS server or an in-store server, or an off-site server 82, such as a retail headquarter server or a chain headquarter server that is off-site but connected to the electronic peripheral 75 or any combination thereof, voice recognition devices 78, wireless devices 77, and RF readers 76 via typical data transmission networks 79.

The electronic peripheral 75 further prompts the cardholder what kind of transactional account would they like to add—personal checking services, credit card services, debit card services, loyalty card services, and the like. The informational elements obtained are temporarily stored in the server 80, local 81 or off-site 82, and may be sent to the Internal Host 83 from the server 80. The server 80 then sends the informational element, the identification number 8, to the Internal Host 83 via data transmission networks 79 wherein the informational element is stored in an Internal Host database 84.

The Internal Host 83 then conducts a negative authorization search of the Internal Host database 84 by searching for a duplicate match of the identification number 8 or a match of the identification number 8 in a negative file. The negative file is a file that contains a transaction history of the individual that indicates whether the individual has unresolved financial issues that would not make them preferable for use of or membership to a HBS card.

The Internal Host 83 also has the ability to conduct a negative authorization search with an External Authorizing Host 85 looking for a match in a negative file that may not be in the Internal Host database 84. The External Authorizing Host 85 that is used for a negative authorization search may be an institution that offers credit cards, debt cards, checking privileges, or any services related to financial transactional accounts; and that keeps records of the financial transactional accounts.

Examples of such institutions may include but are not limited to U.S. banks or international banks, the U.S. Treasury Department's Office of Foreign Asset Control, the Internal Revenue Service, the Department of Homeland Security, credit unions, and consumer credit monitoring agencies. The External Authorizing Host 85 searches an External Authorizing Host database 86 for a match, in a negative file, to the identification number 8 submitted. If a match is found, the step method 40 is terminated and the identification number 8 is placed in a negative file located in the Internal Host database 84. If a negative authorization search does not find a duplicate match or a match in a negative file, the method 200 is allowed to continue.

The Internal Host 83 sends the identification number 8 of the HBS card to the External Authorizing Host 87 for a positive authorization search. The External Authorizing Host 87 used for a positive authorization search is one that maintains secure information relating to informational elements and personal information of the HBS card. Examples of such External Authorizing agents may include but are not limited to a state's Department of Motor Vehicles, the Immigration and Naturalization Service, the Federal Bureau of Investigation, the Internal Revenue Service, the Department of Homeland Security, the Central Intelligence Agency, the International Criminal Police Organization, the National Security Agency, and the like.

The External Authorizing Host 87 searches an External Authorizing Host database 88 for a positive match to the identification number 8 submitted. If the External Authorizing Host 87 finds a match, the host then will send back to the Internal Host 83 informational elements on file in the External Authorizing Host database 88 that correspond to the identification number 8 as well as any personal information that would place the person submitted in a negative file on the Internal Host database 83. Examples of this information may include but are not limited to red flag information such as a stolen driver's license, an illegal alien, a terrorist suspect, an international fugitive, a domestic fugitive, a member of the F.B.I. top ten wanted list, and the like.

Red flag information associated with the identification number 8 will cause the Internal Host 83 to then terminate the method 40 and place the identification number 8 in a negative file. All red flag information related to national security will automatically create an exception file in the Internal Host database 84. The exception file then would be sent to the appropriate national security organization for reconciliation. Examples of national security organizations include but are not limited to the Immigration and Naturalization Service, the Federal Bureau of Investigation, the Internal Revenue Service, the Department of Homeland Security, the Central Intelligence Agency, the International Criminal Police Organization, the National Security Agency, and the like.

If the External Authorizing Host 87 does not find a match to the identification number 8 submitted, the External Authorizing Host 88 will send a file not found notification to the Internal Host 83. The Internal Host 83 will then terminate the method 200 and place identification number 8 of the HBS card in a negative file.

If a negative authorization search yields no matches and a positive authorization yields a match with no red flag information, the electronic peripheral then prompts the cardholder for the transactional account information to be added to the HBS card. In this example, a checking account number. The electronic peripheral 75 reads a MICR of the check to obtain account information, such as a routing number, the checking account number, and the check number. The electronic peripheral 75 may also scan and capture a graphical representation of the check.

Alternatively, it can be envisioned where the check may have a data chip 23 imbedded within the body of the check. It also is envisioned where the data chip 23 may contain account information such as the graphic representation of the check; the routing number; the checking account number; the check number, and the like. The data chip 23 may be read by an electronic peripheral 75 or similar devices.

Alternatively, obtaining checking information from a check may be accomplished via a radio frequency (RF) reader 76. An individual may pass their check over a RF reader 76 which uses a RF transponder to activate the data chip 23 within the card 1. Checking account information such as the graphic representation of the check; the routing number; the checking account number; the check number, and the like would be wirelessly transmitted via radio frequency to the RF reader 76. The RF reader 76 may be a stand alone unit that is connected to the electronic peripheral 75 via standard data transmission lines 79 or the RF reader 76 may be part of the electronic peripheral 75.

Alternatively, it can be envisioned that wireless devices 77 such as cell phones; PDAs such as Palm Pilots™, Handspring Visor™, Handspring Treo™, and the like can be used to provide checking account information. Such devices could provide the account information via scanning technology used to read the MICR, or have the MICR manually inputted into said devices via physical or virtual keyboards.

Alternatively, one can provide checking account information such as the routing number; the checking account number, the check number, and the like via speech technology. Voice recognition software and voice recognition devices 78 are able to transcribe speech into text for use by an electronic peripheral 75. The voice recognition devices 78 may be a stand alone units that are connected to the electronic peripheral 75 via data transmission networks 79 or may be physically part of the electronic peripheral 75.

The checking account information obtained by the electronic peripheral 75, the RF reader 76, wireless devices 77, and the voice recognition devices 78 may be temporarily stored in a server 80 connected to the aforementioned devices via data transmission networks 79. The server 80 may be a local server 81, such as a POS server or an in-store server, or an off-site server 82, such as a retail headquarter server or a chain headquarter server that is off-site but connected to the electronic peripheral 75 or any combination thereof, via voice recognition devices 78, wireless devices 77, and RF readers 76 using typical data transmission networks 79.

The checking account information provided is temporarily stored in the server 80, local 81 or off-site 82, may be sent to the Internal Host 83 from the server 80. The server 80 then sends the account information to the Internal Host 83 via data transmission networks 79 wherein the account information is stored in an Internal Host database 84.

The Internal Host 83 may conduct a negative authorization search of the Internal Host database 84 by searching for a duplicate match of the checking account information or a match in a negative file. The negative file is a file that contains a transaction history of the individual that indicates whether the individual has unresolved financial issues that would not make them preferable for use of or membership to the HBS card.

The Internal Host 83 also has the ability to conduct a negative authorization search with an External Authorizing Host 85 looking for a match in a negative file that may not be in the Internal Host database 84. The External Authorizing Host 85 that is used for a negative authorization search may be an institution that offers credit cards, debt cards, checking privileges, or any services related to financial transactional accounts; and that keeps records of the financial transactional accounts.

Examples of such institutions include but are not limited to U.S. banks or international banks, the U.S. Treasury Department's Office of Foreign Asset Control, the Internal Revenue Service, the Department of Homeland Security, credit unions, and consumer credit monitoring agencies. The External Authorizing Host 85 searches an External Authorizing Host database 86 for a match, in a negative file, to the checking account number submitted. If a match is found, the step 43 is terminated and the account number is placed in a negative file located in the Internal Host database 84. If a negative authorization search does not find a duplicate match or a match in a negative file, the step 43 is allowed to continue.

The Internal Host 83 sends the account information to another External Authorizing Host 87 for a positive authorization search. The External Authorizing Host 87 used for a positive authorization search is one that maintains secure information relating to transactional accounts and personal information related to the account. Examples of such External Authorizing agents may include but are not limited to a state's Department of Motor Vehicles, the Immigration and Naturalization Service, the Federal Bureau of Investigation, the Internal Revenue Service, the Department of Homeland Security, the Central Intelligence Agency, the International Criminal Police Organization, the National Security Agency, and the like.

The External Authorizing Host 87 searches an External Authorizing Host database 88 for a positive match to the account number submitted. If the External Authorizing Host 87 finds a match, the host then will send back to the Internal Host 83 account information on file in the External Authorizing Host database 88 that correspond to the account number as well as any personal information that would place the person submitted in a negative file on the Internal Host database 83. Examples of this information may include but are not limited to red flag information such as a stolen driver's license, an illegal alien, a terrorist suspect, an international fugitive, a domestic fugitive, a member of the F.B.I. top ten wanted list, and the like.

Red flag information associated with the identification number 8 will cause the Internal Host 83 to then terminate the step 43 and place the checking account number in a negative file. All red flag information related to national security will automatically create an exception file in the Internal Host database 84. The exception file then would be sent to the appropriate national security organization for reconciliation. Examples of national security organizations include but are not limited to the Immigration and Naturalization Service, the Federal Bureau of Investigation, the Internal Revenue Service, the Department of Homeland Security, the Central Intelligence Agency, the International Criminal Police Organization, the National Security Agency, and the like.

If the External Authorizing Host 87 does not find a match to checking account number submitted, the External Authorizing Host 88 will send a file not found notification to the Internal Host 83. The Internal Host 83 will then terminate the step 205 and place the account number in a negative file. If a negative authorization search yields no matches and a positive authorization search yields a match with no red flag information, the Internal Host 83 then provides the checking account information to the Internal Host database 84.

Internal Host 83 then generates a unique modifier via computer science methodology. Examples of the methodologies may include but are not limited to off-the-shelf retail software, in-house proprietary software, and the like. The unique modifiers generated may be numerical, alphabetic, symbolic, alpha-numeric, and the like as well as combinations thereof. The Internal Host 83 links the unique modifier generated to the informational element via computer science methodology. Examples may include but are not limited to off-the-shelf retail software, in-house proprietary software, and the like as well as combinations thereof. The informational elements used are elements that have been previously populated in the Internal Host database 84 by the step 41 of the method 40. The result of the steps 95 and 96 is an informational element having a unique modifier ascribed to the informational element.

The Internal Host 83 links the checking account number to the unique modifier previously ascribed to an informational element that was used to populate the Internal Host Database 84. The linking of the checking account number to the unique modifier is accomplished via computer science methodology. Examples may include but are not limited to off-the-shelf retail software, in-house proprietary software, and the like. The checking account will be now linked to the informational element via the unique modifier and stored in the Internal Host database 84.

The result is the HBS card that is now effectively equivalent to a checking account and is afforded any associated checking privileges, through the method 200, providing the HBS card and managing the HBS card. The HBS card can be used for limited check cashing privileges until a positive check cashing history has been achieved. The physical presentation of a check is no longer required for checking services and privileges.

Limited check cashing privileges entail check velocity and check amount limits per week. For example, 2-3 checks may be written for the first three weeks without the aggregate sum not exceeding $300 per week. The second three weeks may include 3-5 checks without the aggregate sum not exceeding $600. Any number of variations of check velocity and check amount limits can be envisioned for developing a positive check cashing history. The more positive a customer's check cashing history is, the greater the check velocity and check amount limits can be.

Alternatively, other transactional accounts such as a credit card may also be added to the HBS card as well as debit cards, loyalty cards, retail cards, membership cards, and the like.

Referring to FIG. 11, the step 206, deleting transactional accounts, as shown in FIG. 4 and FIG. 11, the step 206, an embodiment of the present invention focuses on deleting transactional accounts from the HBS card. A HBS cardholder approaches the electronic peripheral 75 to delete a transactional account. In this example, the transactional account to be deleted is a checking account. The cardholder inserts their HBS card into an electronic peripheral 75. The electronic peripheral 75 reads the HBS card and obtains the informational elements from the card. The cardholder then inputs their PIN and then receives a prompt asking what they would like to do: add a new transactional account, delete a transactional account, or access current HBS account information. Alternatively, the HBS card may be read via a radio frequency (RF) reader 76, wireless devices 77, and voice recognition devices 78.

The informational elements obtained by the electronic peripheral 75, the RF reader 76, wireless devices 77, and the voice recognition devices 78 may be temporarily stored in a server 80 connected to the aforementioned devices via data transmission networks 79. The informational elements obtained that were temporarily stored in the server 80, local 81 or off-site 82, may be sent to the Internal Host 83 from the server 80. The server 80 then sends the informational element, the identification number 8, to the Internal Host 83 via data transmission networks 79 wherein the informational element is stored in an Internal Host database 84.

The Internal Host 83 then conducts a negative authorization search of the Internal Host database 84 by searching for a duplicate match of the identification number 8 or a match of the identification number 8 in a negative file. The negative file is a file that contains a transaction history of the individual that indicates whether the individual has unresolved financial issues that would not make them preferable for use of or membership to a HBS card.

The Internal Host 83 also has the ability to conduct a negative authorization search with an External Authorizing Host 85 looking for a match in a negative file that may not be in the Internal Host database 84. The External Authorizing Host 85 that is used for a negative authorization search may be an institution that offers credit cards, debt cards, checking privileges, or any services related to financial transactional accounts; and that keeps records of the financial transactionactional accounts.

Examples of such institutions include but are not limited to U.S. banks or international banks, the U.S. Treasury Department's Office of Foreign Asset Control, the Internal Revenue Service, the Department of Homeland Security, credit unions, and consumer credit monitoring agencies. The External Authorizing Host 85 searches an External Authorizing Host database 86 for a match, in a negative file, to the identification number 8 submitted. If a match is found, the step method 40 is terminated and the identification number 8 is placed in a negative file located in the Internal Host database 84. If a negative authorization search does not find a duplicate match or a match in a negative file, the method 200 is allowed to continue.

The Internal Host 83 sends the identification number 8 of the HBS card to the External Authorizing Host 87 for a positive authorization search. The External Authorizing Host 87 used for a positive authorization search is one that maintains secure information relating to informational elements and personal information of the HBS card. Examples of such External Authorizing agents may include but are not limited to a state's Department of Motor Vehicles, the Immigration and Naturalization Service, the Federal Bureau of Investigation, the Internal Revenue Service, the Department of Homeland Security, the Central Intelligence Agency, the International Criminal Police Organization, the National Security Agency, and the like.

The External Authorizing Host 87 searches an External Authorizing Host database 88 for a positive match to the identification number 8 submitted. If the External Authorizing Host 87 finds a match, the host then will send back to the Internal Host 83 informational elements on file in the External Authorizing Host database 88 that correspond to the identification number 8 as well as any personal information that would place the person submitted in a negative file on the Internal Host database 83. Examples of this information may include but are not limited to red flag information such as a stolen driver's license, an illegal alien, a terrorist suspect, an international fugitive, a domestic fugitive, a member of the F.B.I. top ten wanted list, and the like.

Red flag information associated with the identification number 8 will cause the Internal Host 83 to then terminate the method 40 and place the identification number 8 in a negative file. All red flag information related to national security will automatically create an exception file in the Internal Host database 84. The exception file then would be sent to the appropriate national security organization for reconciliation. Examples of national security organizations include but are not limited to the Immigration and Naturalization Service, the Federal Bureau of Investigation, the Internal Revenue Service, the Department of Homeland Security, the Central Intelligence Agency, the International Criminal Police Organization, the National Security Agency, and the like.

If the External Authorizing Host 87 does not find a match to the identification number 8 submitted, the External Authorizing Host 88 will send a file not found notification to the Internal Host 83. The Internal Host 83 will then terminate the method 200 and place identification number 8 of the HBS card in a negative file.

If a negative authorization search yields no matches and a positive authorization yields a match with no red flag information, the electronic peripheral 75 further prompts the cardholder what kind of transactional account would they like to delete—personal checking services, credit card services, debit card services, loyalty card services, and the like. The cardholder chooses checking services and is shown all checking accounts currently linked to their HBS card. The customer then chooses which checking account numbers they no longer wish to have ascribed to the HBS card. The choices are sent to the Internal Host 83 which then deletes the chosen checking service from the HBS card. The cardholder no longer has the ability to use the HBS card for the checking service just deleted.

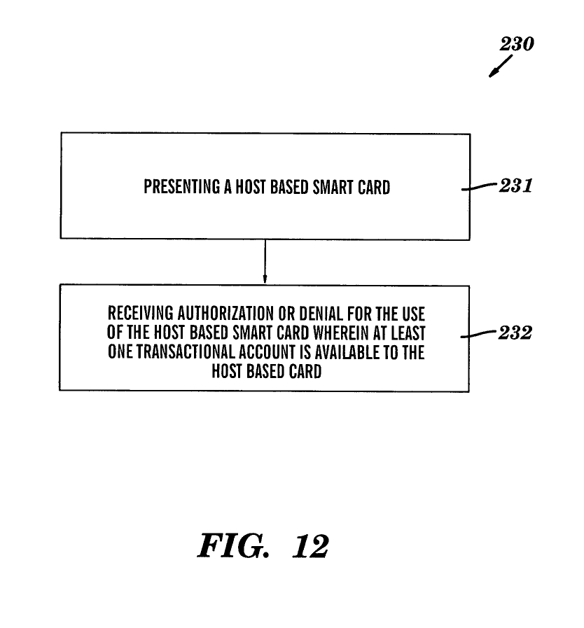

FIG. 12 depicts an embodiment of the present invention, a method 230 for purchasing goods and services using a Host Based Smart card comprising: a step 231, presenting a Host Based Smart card; a step 232, receiving authorization or denial for the use the Host Based Smart card wherein at least one transactional account is available to the Host Based Smart card. As shown in FIG. 4 and FIG. 12, the step 231 of the method 230, presenting the HBS card. An individual possessing the HBS card may approach a provider of goods and services for purchase of the goods and services. The cashier totals the bill and prompts the individual for payment. The individual then presents the HBS card for reconciliation of the bill.

As shown in FIG. 4 and FIG. 12, the step 232, an embodiment of the present invention focuses on receiving authorization or denial for the use the Host Based Smart card wherein at least one transactional account is available to the Host Based Smart card, wherein the transactional account available is a checking account.

The cardholder or cashier inserts the HBS card into an electronic peripheral 75. The electronic peripheral 75 reads the HBS card and obtains the informational elements from the card. The informational elements are sent to the Internal Host 83. The cashier then receives an authorization or denial from the Internal Host 83 for the individual to use their Host Based card with at least one transactional account available to the card. If an authorization is received by the cashier, the cashier then concludes the purchase by cashing out the POS system and the individual leaves with goods or services having been purchased. If a denial is received by the cashier, the cashier then voids the purchase and the individual leaves without any goods or services purchased.

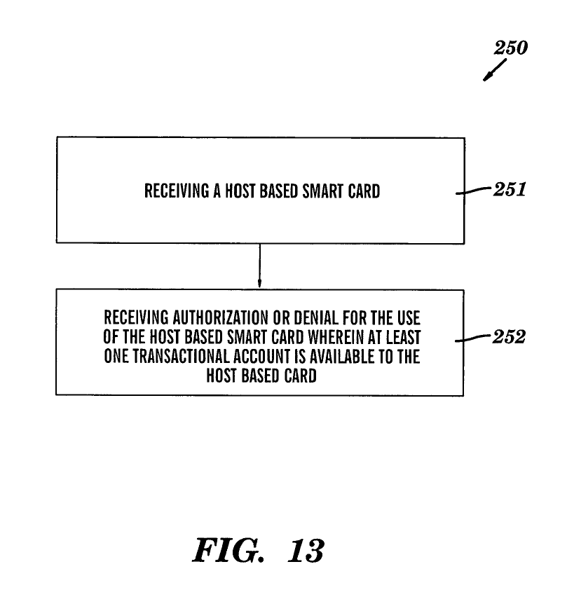

FIG. 13 depicts an embodiment of the present invention, a method 250 for selling goods and services via a Host Based Smart card comprising: a step 251, receiving a Host Based Smart card; and a step 252, receiving authorization or denial for the use the Host Based Smart card wherein at least one transactional account is available to the Host Based Smart card.

As shown in FIG. 4 and FIG. 13, the step 251 of the method 250, receiving the HBS card. A seller of goods and services possess equipment such as an electronic peripheral 75 that is able to receive the HBS card of an individual who wants to purchase goods and services from the seller of the goods and services. The seller totals the bill for goods and services to be purchased and prompts the individual for payment. The individual then presents the HBS card for reconciliation of the bill.

As shown in FIG. 4 and FIG. 13, the step 252, an embodiment of the present invention focuses on receiving authorization or denial for the use the Host Based Smart card wherein at least one transactional account is available to the Host Based Smart card, wherein the transactional account available is a checking account. The individual or the seller insert the HBS card received, from the step 251 of the method 250, into the electronic peripheral 75. The electronic peripheral 75 reads the magnetic stripe 21 or the bar code 22 on the HBS card to obtain the informational element, i.e. the number 8. The electronic peripheral 75 may also scan and capture the graphical representation of the individual 2 of the HBS card 1.

Alternatively, it can be envisioned where the HBS card may have a data chip 23 imbedded within the body of the card. It also is envisioned where the data chip 23 may contain informational elements such as the graphic representation of an individual 2, the residence information 3, the graphic representation of a fingerprint 4, the graphic representation of an individual's iris 5, the representation of an individual's DNA 6, the identification number 8, and the like. The data chip 23 may be read by an electronic peripheral 75 and similar devices.

Alternatively, the seller may receive informational elements from the HBS card via a radio frequency (RF) reader 76. An individual may pass their HBS card over a RF reader 76 which uses a RF transponder to activate the data chip 23 within the card 1. Informational elements such as the graphic representation of an individual 2; the residence information 3, the graphic representation of a fingerprint 4, the graphic representation of an individual's iris 5, the representation of an individual's DNA 6, the identification number 8, and the like would be wirelessly transmitted via radio frequency to the RF reader 76. The RF reader 76 may be a stand alone unit that is connected to the electronic peripheral 75 via standard data transmission lines 79 or the RF reader 76 may be part of the electronic peripheral 75.

Alternatively, the seller may use wireless devices 77 such as cell phones; PDAs such as Palm Pilots™, Handspring Visor™, Handspring Treo™, and the like to receive the informational elements. Such devices could obtain the informational elements via scanning technology used to read the magnetic strip 21 or bar code 23, or have said informational elements manually inputted into said devices via physical or virtual keyboards.

Alternatively, the seller can receive the informational elements like the identification number 8, the address information 3, and the like via speech technology. Voice recognition software and voice recognition devices 78 are able to transcribe speech into text for use by an electronic peripheral 75. The voice recognition devices 78 may be a stand alone units that are connected to the electronic peripheral 75 via data transmission networks 79 or may be physically part of the electronic peripheral 75.

As shown in FIG. 4 and FIG. 13, the step 252, an embodiment of the present invention focuses on receiving authorization or denial for the use the Host Based Smart card wherein at least one transactional account is available to the Host Based Smart card, wherein the transactional account available is a checking account.

The informational elements are sent to the Internal Host 83. The Internal Host 83 then processes request. The seller then receives an authorization or denial from the Internal Host 83 for the individual to use their Host Based card with at least one transactional account available to the card. If an authorization is received by the seller, the seller then concludes the purchase by cashing out the POS system and the individual leaves with goods or services having been purchased. If a denial is received by the seller, the cashier then voids the purchase and the individual leaves without any goods or services purchased.

After the purchase is concluded, the checking account information such as the routing number, the account number, the check number, and the amount of the check are stored as a transaction file. The transaction files may be stored until a specified number of files have been accumulated. Once a predetermined number has been reached, the files then would be batched and sent to the Internal Host 83. The Internal Host 83 forwards the batched files to an Automated Clearing House (ACH) for account reconciliation.

Alternatively, after the purchase is concluded, the checking account information may be sent directly to the Internal Host 83 for storage as a transaction file. The Internal Host may 83 store the transaction files until a specified number of files have been accumulated. Once a predetermined number has been reached, the files then would be batched and sent to an Automated Clearing House (ACH) for account reconciliation.

A financial transaction as used herein is defined as any negotiable item accepted by a financial institution for resolution. Examples of financial transactions may include but are not limited to a single party check transaction or an “on us” check transaction, a third party transaction, a credit card transaction, a debit card transaction, a loyalty card transaction, a membership card transaction, a Host Based Smart (HBS) card transaction, and the like. A single party check transaction is financial transaction where a written check is drawn on a check recipient's bank of deposit.

A third party transaction is a financial transaction which involves an intermediary or agent which accepts the financial transaction from a payee on behalf of payor. Examples of third party transactions include third party check transactions, third party payment transactions, and the like. A third party check transaction is a written check that is drawn on a bank of deposit by a person, business, or bank other than the payee listed on the check.

Examples of third party transaction checks may include but are not limited to payroll checks, refund checks, rebate checks, redeemable coupons, personal checks, federal government checks, state government checks, municipal government checks, money orders, bank deposit checks, and the like. Examples of federal, state, and municipal government checks may include but are not limited to tax refund, unemployment, payroll, Treasury Bond interest, and the like.

A third party payment transaction is a payment that a payment agent or legally authorized entity accepts, as a representative of a creditor, a payment from a payee toward the aforementioned creditor. Examples of third party payment transactions also may include but are not limited to utility payments such as cable, telephone, water, electric, and gas; mortgage payments, credit card, banking services such as deposits and withdrawals, and the like. Examples of HBS card transactions include but are not limited to checking, credit card, debit card, loyalty card, membership card, and the like via a HBS card.

A payee is a person or business to whom money or an amount of money is to be paid, has been paid, or is directed to be paid. Examples may include but are not limited to the person named in a bill of exchange, a note, or a check such as payroll checks, refund checks, rebate checks, redeemable coupons, personal checks, federal government checks, state government checks, municipal government checks, money orders, bank deposit checks, Treasury Bond interest checks, and the like.

A payor is a person, a business, or a government institution who is to pay or has paid money, a note, a bill of exchange, a check, and the like to a payee. Examples of a payor may include but are not limited to an individual, a merchant, a payment agent, federal, state, or local government, and the like.

Financial information are facts, data, input, items, material, and the like that allow a financial transaction to be resolved by a financial institution. Examples of financial information may include but are not limited to a check MICR data, a payee signature, a representation of a check, a credit card number, a representation of a credit card, a debit account number, a representation of a debit card, and the like.

A representation is a physical, a digital, an electronic, an analog, and a visual or tangible rendering of someone or something. Examples may include but are not limited to an electronic or scanned image of a check; credit card, debit card, or checking account numbers in an electronic, a digital, or a wireless format; and the like.

Settling is meant to connote resolving a financial transaction by a financial institution. Financial transactions that may be resolved include single party transactions, third party transactions, credit card transactions, debit card transactions, loyalty card transactions, membership card transactions, Host Based Smart (HBS) card transactions, and the like. Information needed by financial institutions for settling financial transactions include but are not limited to paper checks having MICR data, an image of at least one side of a paper check and its MICR data, an image of at least one side of a paper check with a payee signature, and the like.

Financial institutions typically used include but are not limited to a group consisting a bank of deposit, an Automated Clearing House (ACH) Network, a Clearing Network, a National Automated Clearing House Association (NACHA), a Federal Reserve bank, a Banking Network, and the like. Examples of settling financial transactions may include but are not limited to transactions requiring paying a debt, receiving compensation, receiving payment, and the like via a check, a credit card, a debit card, a HBS card, and combinations thereof through the use of the financial institution.

A Point of Banking (POB) system is a system that accommodates financial transactions. The POB system includes devices selected from a group consisting of a computer, software, electronically controlled cash drawer, a receipt printer, a bar code scanning device, a magnetic card reading device, a check reading device, hardware and software for Internet access and communication, hardware and software for communication with wireless devices, docking bays and ports for communication with flash/temporary memory devices, a display, a terminal, and combinations thereof. Typically, POB systems are dedicated toward financial transactions excluding sales of goods and services. The POB system may be operated by a clerk or teller, or run automatically such as an unmanned kiosk.

Checking indicia are identifying marks or indications on a check, typically used in conducting and completing a financial transaction. Examples may include but are not limited to a check amount (numerical or script), a transaction date, a payee signature, a check MICR number (routing number, account number, and/or check number), payee address, payee driver's license number, recipient name, a “VOID” marking, and combinations thereof.

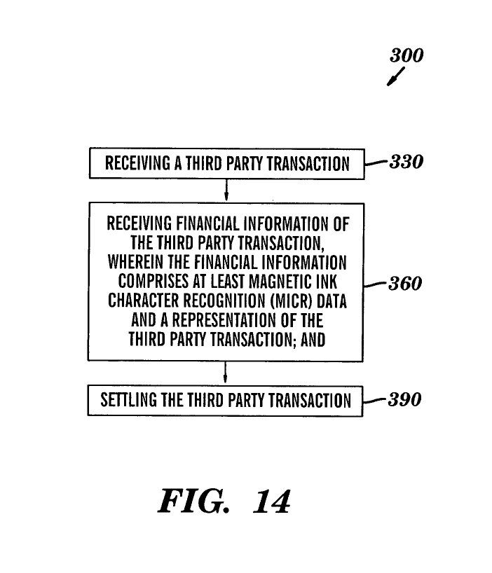

FIG. 14 depicts an embodiment of the present invention, a method 300 for transaction processing comprising: a step 330, receiving a third party transaction; a step 360, receiving financial information of the third party transaction, wherein the financial information comprises at least Magnetic Ink Character Recognition (MICR) data and a representation of said third party transaction; and a step 390, settling the third party transaction.

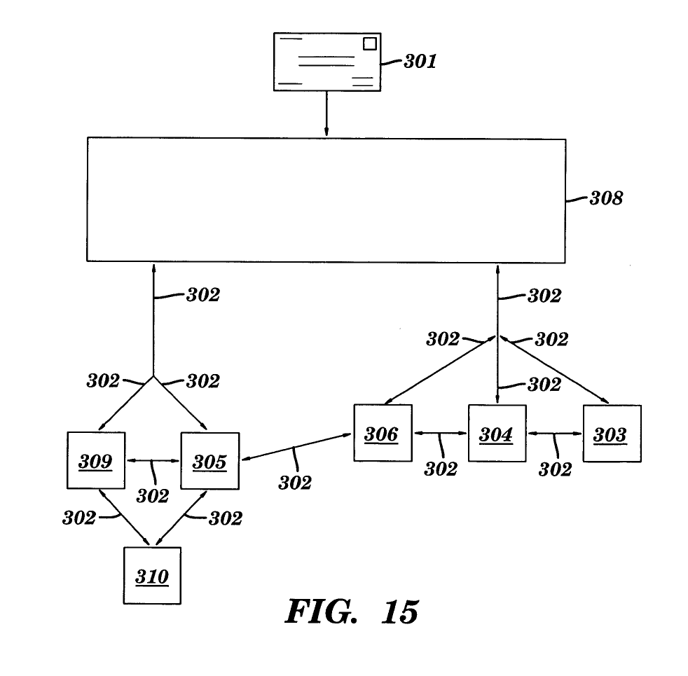

FIG. 15 depicts an embodiment of a system view of the present invention. As shown in FIG. 14 and FIG. 15, the step 330 of the method 300, one embodiment of the present invention focuses on receiving a third party transaction. A merchant or merchant employee receives a third party transaction 301 from a payee at a Point of Banking (POB) system 308 for settlement. The third party transaction 301 is a payroll check in this example.

The payee endorses the payroll check 301 payable to oneself, i.e. the payee, and hands the check 301 to an employee of the payor operating the POB system 308. The payor is a retail merchant in this example. The merchant employee then enters the check 301 amount into the terminal of the POB system 308. The merchant employee requires identification from the payee to proceed with the third party transaction. Typical forms of identification may include but are not limited to federal, state, municipal government issued cards as well as any internationally recognized forms of identification, a HBS card, and the like that allows a merchant to determine the payee's check cashing privileges and identity.

The merchant employee then acquires the payee's check cashing privileges via an Internal Authorizing Host 304 or an External Authorizing Host 303 such as a third party check authorization system or a third-party check guarantee system. A driver's license is a typical form of identification used to evaluate the payee's check cashing privileges. For example, after entering the check 301 total into the POB terminal, the payee's driver's license number or other driver's license data is forwarded via data transmission networks 302 to an External Authorizing Host 303 where the license number is used to retrieve the payee's current check cashing privileges, available limits, checking velocity (number of checks presented per time period), and the like, from the External Authorizing Host 303. Alternatively, the payee's driver's license number may be forwarded to an Internal Authorizing Host 304 which is in communication with the retail merchant server 305 or to another External Host Authorization 306 to determine the payee's check cashing privileges.

As shown in FIG. 14 and FIG. 15, the step 360 of the method 300, one embodiment of the present invention focuses on receiving financial information, wherein the financial information comprises at least a Magnetic Ink Character Recognition (MICR) data and a representation of the third party transaction. Once the merchant employee receives authorization to cash the payroll check from the External Authorizing Host 303 or the Internal Authorizing Host 304, the POB terminal 308 will receive the financial information from the third party transaction, i.e., payroll check 301.

The minimum amount of financial information needed to cash the payee's payroll check 301 or any third party transaction is the MICR data from the check 301 and an image of both sides of the check 301. The merchant employee inserts the check 301 into the POB terminal having an integrated MICR reader, scanner, and printer. The MICR data line then is read, the check 301 printed with the proper transaction indicia, and both sides of the check 301 scanned, with the transaction indicia printed on the check 301, giving an electronic image of the check 301. Alternatively, the aforementioned financial information may be obtained via the MICR reader, the scanner, and the printer which are not integrated with the POB terminal but are in communication with the POB terminal as individual components or combinations thereof of the POB system 308.

The MICR data typically includes the checking account number, the bank routing number, the check number, and the like. The representation of the financial information is the electronic image of the check 301 presented. Examples of the representation can be in an electronic format that may include but are not limited to Joint Photographic Experts Group (JPEG), Tagged Image File (TIF), Portable Document Format (PDF), MicroSoft Macro Media, and the like.

As shown in FIG. 14 and FIG. 15, the step 390 of the method 300, one embodiment of the present invention focuses on settling the third party transaction. Having obtained the financial information of the third party transaction, step 360, the third party transaction is then settled. The payee is given the cash amount for the payroll check 301 submitted and the payroll check 301 then is settled with the underwriting financial institution.

After the payee has been paid by the merchant employee, the employee places the physical, paper check 301 in the register of the POB terminal for temporary storage. The financial information, MICR data and the electronic image of the check 301, also are stored in the POB system 308 memory. The POB terminal receives a transaction complete message after a positive check cashing history is received and is ready for another transaction. Typically at the end of the merchant business day, all checks 301 related to third party transactions are physically collected and securely stored. Alternatively, the merchant employee may return the check 301 to the payee after the check 301 has had the transaction indicia printed on it and has been scanned producing an electronic image of the check 301.

The financial information (the MICR data and the digitally imaged check), in an electronic format, are stored on the merchant server 305. This is done immediately for each third party transaction. At the end of each business day, all electronic data for all of the third party transactions conducted during the day are batched and sent from the merchant server 305 to third party processor 310 or directly to the Financial Institution 309. Typically, the merchant POB terminal or the merchant server 305 sends the batched third party transactions directly to the Financial Institution 309 for settlement if the appropriate third party processing software is installed on the POB system 308.

Alternatively, the electronic data for each third party transaction can be sent real time to the third party processor 310 or directly to the Financial Institution 309 for resolution. Financial Institutions 309 used for resolution include but are not limited to a bank of deposit, an Automated Clearing House (ACH), a Clearing Network, a National Automated Clearing House Association (NACHA), a Federal Reserve bank, and combinations thereof. Typically, three different methods are available for check resolution: settlement of the original paper check by a financial institution, a debit via the ACH, and image exchange of checks with a financial instituition.

Using a payroll check 301 in the above method is not meant to limit the scope of third party transactions that may be used in an embodiment of the present invention. Any third party transaction such as refund checks, rebate checks, redeemable coupons, personal checks, federal government checks, state government checks, municipal government checks, money orders, bank deposit checks, and the like can be used in accordance with the method of the present invention.

Another example for the use of the method 300 for transaction processing of third party transactions is with third party payments. As shown in FIG. 14 and FIG. 15, the step 330 of the method 300, one embodiment of the present invention focuses on receiving a third party transaction. The payee presents a third party transaction at a Point of Banking (POB) system for settlement. The third party transaction in this example is a third party payment, more specifically a cable bill.

The payee fills out and signs a check 301 payable to the service provider, i.e. the cable company, and hands the check 301 to a payment agent for processing. The payment agent endorses the check 301 on behalf of the service provider and enters the check amount into the payment terminal of the POB system 308. The payment terminal may be integrated into the POB system 308 or it may by an independent component in communication with the POB system 308.

The payment agent requires identification from the payee to proceed with the third party payment. Typical forms of identification may include but are not limited federal, state, municipal government issued cards as well as any internationally recognized form of identification, a HBS card, and the like that allows a merchant to determine the payee's check cashing privileges.

The merchant employee then acquires the payee's check cashing privileges via an Internal Authorizing Host 304 or an External Authorizing Host 303 such as a third party check authorization system or a third party check guarantee system. A driver's license is a typical form of identification used to evaluate the payee's check cashing privileges. For example, after entering the payment total into the payment terminal, the payee's driver's license number or other driver's license data is forwarded via data transmission networks 302 to an External Authorizing Host 303 where the license number is used in retrieving the payee's current check cashing privileges, available limits, checking velocity (number of checks presented per time period), and the like, from the External Authorizing Host 303. Alternatively, the payee's driver's license number may be forwarded to an Internal Authorizing Host 304 which is in communication with the retail merchant server 305 or to another External Host Authorization 306 to determine the payee's check cashing privileges.

As shown in FIG. 14 and FIG. 15, the step 360 of the method 300, one embodiment of the present invention focuses on receiving financial information, wherein the financial information comprises at least a Magnetic Ink Character Recognition (MICR) data and a representation of the third party transaction. In this example, the third party transaction is a third party payment. Once the payment agent receives authorization that the payee has cashing and third party cashing privileges from the External Authorizing Host 303 or the Internal Authorizing Host 304, the payment terminal will receive the financial information from the third party payment, i.e., the check 301.

The minimum amount of financial information needed for the payment agent to accept the third party payment or any third party transaction is the MICR data from the check 301 and a representation of the financial information. In this example, the representation is an electronic image of both sides of the check 301. The payment agent inserts the check 301 into the POB system 308 or the payment terminal having an integrated MICR reader, scanner, and printer. The MICR data line of the check 301 then is read, the check 301 printed with the proper transaction indicia on it, and both sides of the check 301 scanned, with the transaction indicia printed on the check 301, giving an electronic image of the check 301. Alternatively, the aforementioned financial information may be obtained via the MICR reader, the scanner, and the printer which are not integrated with the POB system 308 or the payment terminal but are in communication with the POB system 308 or the terminal as individual components or combinations thereof.

The MICR data typically includes the checking account number, the bank routing number, and the check number. The representation of the financial information is the electronic image of the check 301 presented for third party payment. Examples of the representation can be in an electronic format that may include but are not limited to Joint Photographic Experts Group (JPEG), Tagged Image File (TIF), Portable Document Format (PDF), MicroSoft Macro Media, and the like.

As shown in FIG. 14 and FIG. 15, the step 390 of the method 300, one embodiment of the present invention focuses on settling the third party transaction after having obtained the financial information of the third party transaction, step 360. The third party transaction is the third party payment in this example. The payee is given a receipt for the amount paid toward the cable bill.

After the payee has received the receipt for payment, the payment agent places the physical, paper check 301 in the register of the POB system 308 or the register of the payment terminal for temporary storage. The financial information, MICR data and the electronic image of the check 301, also are stored in the POB system 308 or payment terminal memory. The POB system 308 or payment terminal receives a transaction complete message after a positive check cashing history is received and is ready for another transaction. Typically at the end of the business day, all checks 301 related to third party payments are collected and securely stored. Alternatively, the payment agent may return the check 301 to the payee after the check 301 has had the transaction indicia printed on it and has been scanned producing an electronic image of the check 301.

The financial information (the MICR data and the digitally imaged check), in an electronic format, are stored on the agent server 305. This is done immediately for each third party payment. Typically at the end of each business day, all electronic data for all of the third party payments made during the day are batched and sent from the payment terminal server 305 to a third party processor 310 which in turn sends the batched payments to the utility company or directly to the utility company 309. In this example the utility company is the cable company the check 301 was written to. Typically, the merchant POB system 308 or the merchant server 305 should have the appropriate third party processing software to send batched third party payments directly to the cable company 309. Alternatively, the electronic data for each third party transaction can be sent real time to the third party processor 310 or directly to the cable company 309 for resolution.

Using the example of the cable bill as a third party payment that may be resolved in the above method is not meant to limit the scope of third party payments that may be used in an embodiment of the present invention. Any third party payment such as telephone, water, electric, and gas; mortgage payments, credit card, banking services such as deposits and withdrawals, and the like can be used in accordance with the method of the present invention.

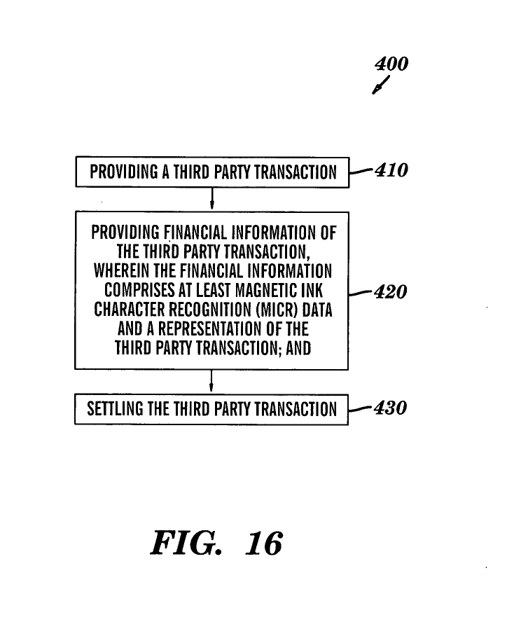

FIG. 16 depicts another embodiment of the present invention, a method 400 for transaction processing comprising: a step 410, providing a third party transaction; a step 420, providing financial information of the third party transaction, wherein the financial information comprises at least Magnetic Ink Character Recognition (MICR) data and a representation of said third party transaction; and a step 430, settling the third party transaction.

As shown in FIG. 14 and FIG. 16, the step 420 of the method 410, one embodiment of the present invention focuses on providing a third party transaction. A payee provides or presents a third party transaction 301 at a Point of Banking (POB) 308 system for settlement. The third party transaction 301 is a payroll check in this example.

The payee endorses the payroll check 301 payable to oneself, i.e. the payee, and hands the check 301 to an employee of the payor operating the POB system 308. The payor is a retail merchant in this example. The merchant employee then enters the check 301 amount into the POB system 308. The merchant employee requires identification from the payee to proceed with the third party transaction. Typical forms of identification may include but are not limited federal, state, municipal government issued cards as well as any internationally recognized form of identification, a HBS card, and the like that allows a merchant to determine the payee's check cashing privileges.

The merchant employee then acquires the payee's check cashing privileges via an Internal Authorizing Host 304 or an External Authorizing Host 303 such as a third-party check authorization system or a third-party check guarantee system. A driver's license is a typical form of identification used to evaluate the payee's check cashing privileges and identity. For example, after entering the check 301 total into the POB system 308, the payee's driver's license number or other driver's license data is forwarded via data transmission networks 302 to an External Authorizing Host 303 where the license number is used in retrieving the payee's current check cashing privileges, available limits, checking velocity (number of checks presented per time period), and the like, from the External Authorizing Host 303. Alternatively, the payee's driver's license number may be forwarded to an Internal Authorizing Host 304 which is in communication with the retail merchant server 305 or to another External Host Authorization 306 to determine the payee's check cashing privileges.

As shown in FIG. 15 and FIG. 16, the step 420 of the method 400, one embodiment of the present invention focuses on providing financial information, wherein the financial information comprises at least a Magnetic Ink Character Recognition (MICR) data and a representation of the third party transaction. Once the merchant employee receives authorization to cash the payroll check from the External Authorizing Host 303 or the Internal Authorizing Host 304, the payee provides the financial information related to the third party transaction, e.g. payroll check, to the merchant employee at the POB system 308.

The minimum amount of financial information needed to cash the payee's payroll check 301 or any third party transaction is the MICR data from the check 301 and a representation of the financial information. In this example, the representation is an electronic image of both sides of the check 301. The merchant employee inserts the check 301 into the terminal of the POB system 308 having an integrated MICR reader, scanner, and printer. The MICR data line then is read, the check printed with the proper transaction indicia. The payee then has the option of providing an electronic image of the check 301 to the POB system 308. This can be done via cell phones; personal digital assistants (PDA) such as Palm Pilots™, Handspring Visor™, Handspring Treo™; and the like.

If the payee can not provide an electronic image of the check 301, the paper check presented may be scanned by the scanner of the POS system 308, with the transaction indicia printed on the check, giving an electronic image of the check 301. Alternatively, the aforementioned financial information may be obtained via the MICR reader, the scanner, and the printer which are not integrated with the POB system 308 but are in communication with POB system 308 as individual components or combinations thereof.

The MICR data typically includes the checking account number, the bank routing number, and the check number. The representation of the financial information is the electronic image of the check 301 presented. Examples of the representation can be in an electronic format that may include but are not limited to Joint Photographic Experts Group (JPEG), Tagged Image File (TIF), Portable Document Format (PDF), MicroSoft Macro Media, and the like.

As shown in FIG. 15 and FIG. 16, the step 430 of the method 400, one embodiment of the present invention focuses on settling the third party transaction. Having obtained the financial information of the third party transaction, step 420, the third party transaction is then settled. The payee is given the cash amount for the payroll check 301 submitted and the payroll check 301 then is resolved with the underwriting financial institution.

After the payee has been paid by the merchant employee, the employee places the physical, paper check 301 in the register of the POB system 308 for temporary storage. The financial information, MICR data and the electronic image of the check 301, also are stored in the POB system 308 memory. The POB system 308 receives a transaction complete message after a positive check cashing history is received and is ready for another transaction. Typically at the end of the merchant business day, all checks 301 related to third party transactions are collected and securely stored. Alternatively, the merchant employee may return the check 301 to the payee after the check 301 has had the transaction indicia printed on it and has been scanned producing an electronic image of the check 301.

The financial information (the MICR data and the digitally imaged check), in an electronic format, are stored on the merchant server 305. This is done immediately for each third party transaction. Typically at the end of each business day, all electronic data for all of the third party transactions conducted during the day are batched and sent from the merchant server 305 to a third party processor 310 or directly to the Financial Institution 309. Typically, the merchant POB system 308 or the merchant server 305 should have the appropriate third party processing software to send batched third party transactions directly to the Financial Institution 309.

Alternatively, the electronic data for each third party transaction can be sent real time to the third party processor 310 or directly to the Financial Institution 309 for resolution. Financial Institutions 309 used for resolution include but are not limited to a bank of deposit, an Automated Clearing House (ACH), a Clearing Network, a National Automated Clearing House Association (NACHA), a Federal Reserve bank, and combinations thereof.

Using a payroll check 301 in the above method is not meant to limit the scope of third party transactions that may be used in an embodiment of the present invention. Any third party transaction such as refind checks, rebate checks, redeemable coupons, personal checks, federal government checks, state government checks, municipal government checks, money orders, bank deposit checks, and the like can be used in accordance with the method of the present invention.

Another example for the use of the method 400 for transaction processing of third party transaction is with third party payments. As shown in FIG. 15 and FIG. 16, the step 410 of the method 400, one embodiment of the present invention focuses on providing a third party transaction. The payee provides or presents a third party transaction at a Point of Banking (POB) system 308 for settlement. The third party transaction in this example is a third party payment, more specifically a cable bill.

The payee fills out and signs a check 301 payable to the service provider, e.g. the cable company, and hands the check 301 to a payment agent for processing. The payment agent endorses the check 301 on behalf of the service provider and enters the check amount into the POB system 308 or a payment terminal of the POB system 308. The payment terminal may be integrated into the POB system 308 or it may by an independent component in communication with the POB system 308.

The payment agent requires identification from the payee to proceed with the third party payment. Typical forms of identification may include but are not limited too federal, state, municipal government issued cards as well as any internationally recognized form of identification, and the like that allows a merchant to determine the payee's check cashing privileges.

The merchant employee then acquires the payee's check cashing privileges via an Internal Authorizing Host 304 or an External Authorizing Host 303 such as a third party check authorization system or a third party check guarantee system. A driver's license is a typical form of identification used to evaluate the payee's check cashing privileges and identity. For example, after entering the payment total into the payment terminal, the payee's driver's license number or other driver's license data is forwarded via data transmission networks 302 to an External Authorizing Host 303 where the license number is used to retrieve the payee's current check cashing privileges, available limits, checking velocity (number of checks presented per time period), and the like, from the External Authorizing Host 303. Alternatively, the payee's driver's license number may be forwarded to an Internal Authorizing Host 304 which is in communication with the retail merchant server 305 or to another External Host Authorization 306 to determine the payee's check cashing privileges.

As shown in FIG. 15 and FIG. 16, the step 420 of the method 400, one embodiment of the present invention focuses on providing financial information, wherein the financial information comprises at least a Magnetic Ink Character Recognition (MICR) data and a representation of the third party transaction. In this example, the third party transaction is a third party payment. Once the payment agent receives authorization that the payee has cashing and third party cashing privileges from the External Authorizing Host 303 or the Internal Authorizing Host 304, the payee provides or presents the financial information related to the third party payment, i.e., the check 301, to the payment agent.

The minimum amount of financial information needed for the payment agent to accept the third party payment or any third party transaction is the MICR data from the check 301 and an image of both sides of the check 301. The payment agent inserts the check 301 into the POB system having an integrated MICR reader, scanner, and printer. The MICR data line then is read and the check printed with the proper transaction indicia. The payee then has the option of providing an electronic image of the check 301 to the POS system 308. This can be done via cell phones; PDAs such as Palm Pilots™, Handspring™ Visor™, Handspring™ Treo™, and other hand held devices capable of storing an electronic image of the payee's check, and the like.

If the payee can not provide an electronic image of the check 301, the paper check previously presented may be copied by the scanner of the POB system 308, with the transaction indicia printed on the check, giving an electronic image of the check 301. Alternatively, the aforementioned financial information may be obtained via the MICR reader, the scanner, and the printer which are not integrated with the POB system 308 or payment terminal but are in communication with the POB system 308 or the terminal as individual components or combinations thereof.

The MICR data typically includes the checking account number, the bank routing number, and the check number. The representation of the financial information is the electronic image of the check 301 presented for third party payment. Examples of the representation can be in an electronic format that may include but are not limited to Joint Photographic Experts Group (JPEG), Tagged Image File (TIF), Portable Document Format (PDF), MicroSoft Macro Media, and the like.

As shown in FIG. 15 and FIG. 16, the step 430 of the method 400, one embodiment of the present invention focuses on settling the third party transaction after having obtained the financial information of the third party transaction, step 420. The third party transaction is the third party payment in this example. The payee is given a receipt for the amount paid toward the cable bill.

After the payee has received the receipt for payment, the payment agent places the physical, paper check 301 in the register of the POB system 308 or the register of the payment terminal for temporary storage. The financial information, MICR data and the electronic image of the check 301, also are stored in the POB system 308 or payment terminal memory. The POB system 308 or payment terminal receives a transaction complete message after a positive check cashing history is received and is ready for another transaction. Typically at the end of the business day, all checks 301 related to third party payments are collected and securely stored. Alternatively, the payment agent may return the check 301 to the payee after the check 301 has had the transaction indicia printed on it and has been scanned producing an electronic image of the check 301.

The financial information (the MICR data and the digitally imaged check), in an electronic format, are stored on the agent server 305. This is done immediately for each third party payment. Typically at the end of each business day, all electronic data for all of the third party payments conducted during the day are batched and sent from the payment terminal server 305 to a third party processor 310 which in turn sends the batched payments to the utility company or directly to the utility company 309.

In this example the utility company is the cable company the check 301 was written to. Typically, the merchant POB system 308 or the server 305 should have the appropriate third party processing software to send batched third party payments directly to the cable company 309. Alternatively, the electronic data for each third party transaction can be sent real time to the third party processor 310 or directly to the Financial Institution 309 for resolution. Financial Institutions 309 used for resolution include but are not limited to a bank of deposit, an Automated Clearing House (ACH), a Clearing Network, a National Automated Clearing House Association (NACHA), a Federal Reserve bank, and combinations thereof.

Use of the cable bill as an example of a third party payment that may be resolved in the above method is not meant to limit the scope of third party payments that may be used in an embodiment of the present invention. Any third party payment such as telephone, water, electric, and gas; mortgage payments, credit card, banking services such as deposits and withdrawals, and the like can be used in accordance with the method of the present invention.

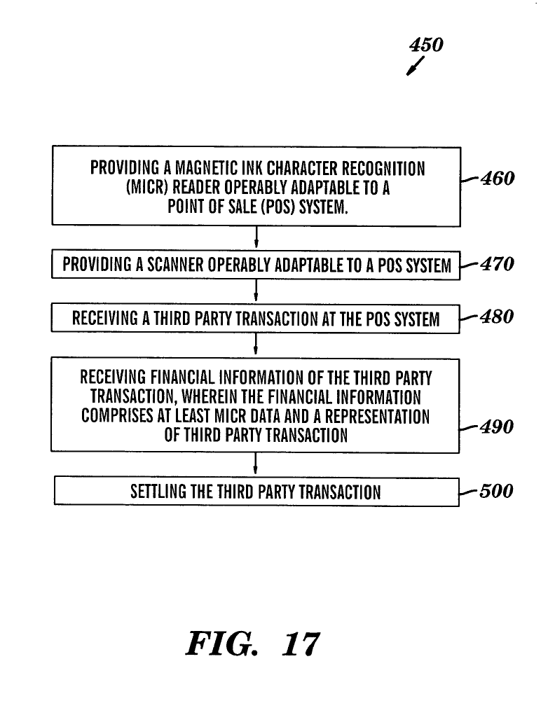

FIG. 17 depicts an embodiment of the present invention, a method 450 for transaction processing comprising: a step 460, providing a Magnetic Ink Character Recognition (MICR) data reader operably adaptable to a Point of Banking (POB) system 308; a step 470, providing a scanner operably adaptable to a POB system 308; a step 480, receiving a third party transaction at the POB system 308; a step 490, receiving financial information of the third party transaction, wherein the financial information comprises at least MICR data and a representation of said third party transaction; and a step 500, settling the third party transaction.

As shown in FIG. 15 and FIG. 17, the step 460 of the method 450, one embodiment of the present invention focuses on providing the MICR data reader operably adaptable to the Point of Banking (POB) system 308. A MICR data reader is used to read the MICR data on the bottom of checks. MICR data typically includes the checking account number, the bank routing number, the check number, and the like. The MICR data reader is operably attached to a POB system 308 as to enable the POB system 308 to receive MICR data.

As shown in FIG. 15 and FIG. 17, the step 470 of the method 450, one embodiment of the present invention focuses on providing a scanner operably adaptable to the POB system 308. The scanner is operably attached to the POB system 308 such as to enable the POB system 308 to receive electronic or digital images created by the scanner. The scanner is used to copy and create digital images of the financial information.

As shown in FIG. 15 and FIG. 17, the step 480 of the method 450, one embodiment of the present invention focuses on receiving a third party transaction. A merchant or merchant employee receives a third party transaction 301 from a payee at a POB system 308 for settlement. The third party transaction 301 is a payroll check in this example.

The payee endorses the payroll check 301 payable to oneself, e.g. the payee, and hands the check 301 to an employee of the payor operating the POB system 308. The payor is a retail merchant in this example. The merchant employee then enters the check 301 amount into the POB system 308. The merchant employee requires identification from the payee to proceed with the third party transaction. Typical forms of identification may include but are not limited federal, state, municipal government issued cards as well as any internationally recognized form of identification, and the like that allows a merchant to determine the payee's check cashing privileges.

The merchant employee then acquires the payee's check cashing privileges via an Internal Authorizing Host 304 or an External Authorizing Host such as a third-party check authorization system or a third-party check guarantee system. A driver's license is a typical form of identification used to evaluate the payee's check cashing privileges and identity. For example, after entering the check 301 total into the POB system 308, the payee's driver's license number or other driver's license data is forwarded via data transmission networks 302 to an External Authorizing Host 303 where the license number is used in retrieving the payee's current check cashing privileges, available limits, checking velocity (number of checks presented per time period), and the like, from the External Authorizing Host 303. Alternatively, the payee's driver's license number may be forwarded to an Internal Authorizing Host 304 which is in communication with the retail merchant server 305 or to another External Host Authorization 306 to determine the payee's check cashing privileges.

As shown in FIG. 15 and FIG. 17, the step 490 of the method 500, one embodiment of the present invention focuses on receiving financial information, wherein the financial information comprises at least a Magnetic Ink Character Recognition (MICR) data and a representation of the third party transaction. Once the merchant employee receives authorization to cash the payroll check from the External Authorizing Host 303 or the Internal Authorizing Host 304, the POB system 308 will receive the financial information from the third party transaction, e.g., payroll check.

The minimum amount of financial information needed to cash the payee's payroll check 301 or any third party transaction is the MICR data from the check 301 and a representation of the financial information. In this example, the representation is an image of both sides of the check 301. The merchant employee inserts the check 301 into the POB system 308 having an integrated MICR reader, scanner, and printer. The MICR data line then is read, the check printed with the proper transaction indicia, and both sides of the check 301 scanned, with the transaction indicia printed on the check, giving an electronic image of the check 301. Alternatively, the aforementioned financial information may be obtained via the MICR reader, the scanner, and the printer which are not integrated with the POB system 308 but are in communication with POB system 308 as individual components or combinations thereof.

The MICR data typically includes the checking account number, the bank routing number, and the check number. The representation of the financial information is the electronic image of the check 301 presented. Examples of the representation can be in an electronic format that may include but are not limited to Joint Photographic Experts Group (JPEG), Tagged Image File (TIF), Portable Document Format (PDF), MicroSoft Macro Media, and the like.

As shown in FIG. 15 and FIG. 17, the step 500 of the method 450, one embodiment of the present invention focuses on settling the third party transaction. Having obtained the financial information of the third party transaction, step 490, the third party transaction is then settled. The payee is given the cash amount for the payroll check 301 submitted and the payroll check 301 then is resolved with the underwriting financial institution.

After the payee has been paid by the merchant employee, the employee places the physical, paper check 301 in the register of the POB system 308 for temporary storage. The financial information, MICR data and the electronic image of the check 301, also are stored in the POB system 308 memory. The POB system 308 receives a transaction complete message after a positive check cashing history is received and is ready for another transaction. Typically at the end of the merchant business day, all checks 301 related to third party transactions are collected and securely stored. Alternatively, the merchant employee may return the check 301 to the payee after the check 301 has had the transaction indicia printed on it and has been scanned producing an electronic image of the check 301.

The financial information (the MICR data and the digitally imaged check), in an electronic format, are stored on the merchant server 305. This is done for each third party transaction. Typically at the end of each business day, all electronic data for all of the third party transactions made during the day are batched and sent from the merchant server 305 to a third party processor 310 or directly to the Financial Institution 309.

Typically, the merchant POB system 308 or the merchant server 305 should have the appropriate third party processing software to send batched third party transactions directly to the Financial Institution 309. Alternatively, the electronic data for each third party transaction can be sent real time to the third party processor 310 or directly to the Financial Institution 309 for resolution. Financial Institutions 309 used for resolution include but are not limited to a bank of deposit, an Automated Clearing House (ACH), a Clearing Network, a National Automated Clearing House Association (NACHA), a Federal Reserve bank, and combinations thereof.

Using a payroll check 301 in the above method is not meant to limit the scope of third party transactions that may be used in an embodiment of the present invention. Any third party transaction such as refund checks, rebate checks, redeemable coupons, personal checks, federal government checks, state government checks, municipal government checks, money orders, bank deposit checks, and the like can be used in accordance with the method of the present invention.

Transaction processing methods 300, 400, and 450 are examples of methods often referred to as “front office” processing or conversion. Most of the steps of each method 300, 400, and 450; providing a check 301, receiving the check 301, scanning the check 301, receiving financial information, etc, generally occur at the POB system 308 and specifically the POB terminal typically located in a public area or a business area. Alternatively, another method for transaction processing is referred to as “back office” processing or conversion.

Back office conversion methods for transaction processing occur in a back office or an area of a merchant generally not accessible to the public in which paper checks were initially received at a POS system or a POB terminal. For example, a merchant or merchant employee receives a third party transaction 301 from a payee at a Point of Banking (POB) system 308 or a POS system for settlement. The third party transaction 301 is a payroll check in this example. The payee endorses the payroll check 301 payable to oneself, i.e. the payee, and hands the check 301 to an employee of the payor operating the POB system 308. The payor is a retail merchant in this example. The merchant employee then enters the check 301 amount into the terminal of the POB system 308. The merchant employee requires identification from the payee to proceed with the third party transaction. Typical forms of identification may include but are not limited to federal, state, municipal government issued cards as well as any internationally recognized forms of identification, a HBS card, and the like that allows a merchant to determine the payee's check cashing privileges and identity.

The merchant employee then acquires the payee's check cashing privileges via an Internal Authorizing Host 304 or an External Authorizing Host 303 such as a third party check authorization system or a third-party check guarantee system. A driver's license is a typical form of identification used to evaluate the payee's check cashing privileges. For example, after entering the check 301 total into the POB terminal, the payee's driver's license number or other driver's license data is forwarded via data transmission networks 302 to an External Authorizing Host 303 where the license number is used to retrieve the payee's current check cashing privileges, available limits, checking velocity (number of checks presented per time period), and the like, from the External Authorizing Host 303. Alternatively, the payee's driver's license number may be forwarded to an Internal Authorizing Host 304 which is in communication with the retail merchant server 305 or to another External Host Authorization 306 to determine the payee's check cashing privileges.

Once the merchant employee receives authorization to cash the payroll check from the External Authorizing Host 303 or the Internal Authorizing Host 304, the payee is given the cash amount for the payroll check 301 submitted. After the payee has been paid by the merchant employee, the employee places the physical, paper check 301 in the register of the POB terminal for temporary storage and settlement with the underwriting financial institution at a later time. At the end of each business day or some predetermined time period, the checks 301 that have been collected and paid out are processed for final resolution. Prior to settlement, all checks 301 received during the business day are imaged and batched at a central location.

The minimum amount of financial information needed to process the checks 301 or any third party transaction in the back office conversion method is the MICR data from the check 301 and an image of both sides of the check 301. Capture of the MICR data and the image of the checks 301 is not done at the checkout but a back office location with the appropriate equipment such as MICR data readers and scanners.

The foregoing description of the embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included withing the scope of this invention as defined by the accompanying claims.

1. A method of transaction processing comprising:
receiving a third party transaction;
receiving financial information of said third party transaction, wherein said financial information comprises at least a Magnetic Ink Character Recognition (MICR) data and a representation of said third party transaction; and
settling said third party transaction.

2. The method of claim 1, wherein said third party transaction is selected from the group consisting of a payroll check, a refund check, a rebate check, a redeemable coupon, a personal check, a federal government check, a state government check, a municipal government check, a money order, a bank deposit check, a third party check, a third party payment, a financially negotiable item, and combinations thereof.

3. The method of claim 2, wherein said third party payment is selected from the group consisting of payments consisting of cable, telephone, water, electric, gas, mortgage, credit card, bank withdrawals, and combinations thereof.

4. The method of claim 1, wherein receiving financial information of said third party transaction occurs at one selected from the group consisting of a Point of Sales (POS) system, a Point of Banking (POB) terminal, and combinations thereof.

5. The method of claim 4, wherein the POB terminal includes devices selected from the group consisting of a computer, software, electronically controlled cash drawer, a receipt printer, a bar code scanning device, a magnetic card reading device, a check reading device, hardware and software for Internet access and communication, hardware and software for communication with wireless devices, docking bays and ports for communication with flash/temporary memory devices, a display, and combinations thereof.

6. The method of claim 1, wherein the financial information includes information is selected from the group consisting of a name, an address, a phone number, an e-mail address, a Personal Identification Number (PIN), a bank account number, an account routing number, a check number, a signature, an image of said signature, a physical check, an image of a blank check, an image of a completed check, a check amount, informational elements, and combinations thereof.

7. The method of claim 6, wherein said information elements are selected from the group consisting of a representation of an individual, a representation of a fingerprint, a representation of an individual's iris, a representation of an individual's DNA, a retinal scan, a Host Based Smart Card, and combinations thereof.

8. The method of claim 1, wherein said representation is selected from the group consisting of a physical, a digital, an electronic, an analog, and a visual or tangible rendering of someone or something that accurately depicts the individual or an object being represented, and combinations thereof.

9. The method of claim 1, wherein settling said third party transaction includes resolving said third party transaction with a financial institution.

10. The method of claim 9, wherein said financial institution is selected from the group consisting a bank of deposit, an Automated Clearing House (ACH), a Clearing Network, a National Automated Clearing House Association (NACHA), a Federal Reserve bank, and combinations thereof.

11. The method of claim 1, wherein said third party transaction is a third party check.

12. The method of claim 1, wherein said third party transaction is a third party payment.

13. A method of transaction processing comprising:
providing a Magnetic Ink Character Recognition (MICR) reader operably adaptable to a Point of Banking (POB) terminal;
providing a scanner operably adaptable to said POB terminal;
receiving a third party transaction at said POB terminal;
receiving financial information of said third party transaction, wherein said financial information comprises at least said MICR data and a representation of said third party transaction; and
settling said third party transaction.

14. The method of claim 13, wherein said third party transaction is selected from the group consisting of a payroll check, a refund check, a rebate check, a redeemable coupon, a personal check, a federal government check, a state government check, a municipal government check, a money order, a bank deposit check, a third party payment, a financially negotiable item, and combinations thereof.

15. The method claim 14, wherein said third party payment is selected from the group of payments consisting of cable, telephone, water, electric, gas, mortgage, credit card, a bank withdrawal, and combinations thereof.

16. The method of claim 13, wherein receiving financial information of said third party transaction occurs one selected from the group consisting of at a Point-of Sales (POS) system, a POB terminal, and combinations thereof.

17. The method of claim 16, wherein the POB terminal includes devices selected from the group comprising of a computer, software, electronically controlled cash drawer, a receipt printer, a bar code scanning device, a magnetic card reading device, a check reading device, hardware and software for Internet access and communication, hardware and software for communication with wireless devices, docking bays and ports for communication with flash/temporary memory devices, a display, and combinations thereof.

18. The method of claim 13, wherein the financial information includes information selected from a group consisting of a name, an address, a phone number, an e-mail address, a Personal Identification Number (PIN), a bank account number, an account routing number, a check number, a signature, an image of said signature, a physical check, an image of a blank check, an image of a completed check, a check amount, informational elements, and combinations thereof.

19. The method of claim 18, wherein said information elements are selected from the group consisting of a representation of an individual, a representation of a fingerprint, a representation of an individual's iris, a of an individual's DNA, a retinal scan, a Host Based Smart Card, and combinations thereof.

20. The method of claim 13, wherein said representation is selected from the group consisting of a physical, a digital, an electronic, an analog, and a visual or tangible rendering of someone or something that accurately depicts the individual or an object being represented, and combinations thereof.

21. The method of claim 13, wherein settling said third party transaction includes resolving said third party transaction with a financial institution.

22. The method of claim 21, wherein said financial institution is selected from the group consisting a bank of deposit, an Automated Clearing House (ACH), a Clearing Network, a National Automated Clearing House Association (NACHA), a Federal Reserve bank, and combinations thereof.

23. The method of claim 13, wherein said third party transaction is a third party check.

24. The method of claim 13, wherein said third party transaction is a third party payment.

25. A method of transaction processing comprising:
providing a third party transaction;
providing financial information of said third party transaction, wherein said financial information comprises at least a Magnetic Ink Character Recognition (MICR) data and a representation of said third party transaction; and
settling said third party transaction.

26. The method of claim 25, wherein said third party transaction is selected from the group consisting of a payroll check, a refund check, a rebate check, a redeemable coupon, a personal check, a federal government check, a state government check, a municipal government check, a money order, a bank deposit check, a third party payment, a financially negotiable item, and combinations thereof.

27. The method claim 26, wherein said third party payment is selected from the group of payments consisting of cable, telephone, water, electric, gas, mortgage, credit card, a bank deposit, a bank withdrawal, and combinations thereof.

28. The method of claim 25, wherein receiving financial information of said third party transaction occurs one selected from the group consisting of at a Point-of Sales (POS) system, a Point of Banking terminal, and combinations thereof.

29. The method of claim 25, wherein the POB terminal includes devices selected from the group consisting of a computer, software, electronically controlled cash drawer, a receipt printer, a bar code scanning device, a magnetic card reading device, a check reading device, hardware and software for Internet access and communication, hardware and software for communication with wireless devices, docking bays and ports for communication with flash/temporary memory devices, a display, and combinations thereof.

30. The method of claim 25, wherein said financial information includes information selected from the group consisting of a name, an address, a phone number, an e-mail address, a Personal Identification Number (PIN), a bank account number, an account routing number, a check number, a signature, an image of said signature, a physical check, an image of a blank check, an image of a completed check, a check amount, informational elements, and combinations thereof.

31. The method of claim 30, wherein said information elements are selected from a group consisting of a representation of an individual, a representation of a fingerprint, a representation of an individual's iris, a representation of an individual's DNA, a retinal scan, a Host Based Smart Card, and combinations thereof.

32. The method of claim 25, wherein said representation is selected from the group consisting of a physical, a digital, an electronic, an analog, and a visual or tangible rendering of someone or something that accurately depicts the individual or an object being represented, and combinations thereof.

33. The method of claim 25, wherein settling said third party transaction includes resolving said third party transaction with a financial institution.

34. The method of claim 33, wherein said financial institution is selected from the group consisting of bank of deposit, an Automated Clearing House (ACH), a Clearing Network, a National Automated Clearing House Association (NACHA), a Federal Reserve bank, and combinations thereof.

35. The method of claim 25, wherein said third party transaction is a third party check.

36. The method of claim 25, wherein said third party transaction is a third party payment.
